(19) United States
(12) Patent Application Publication
(10) Pub. No.: US 2010/0310754 A1
(43) Pub. Date: Dec. 9, 2010

(54) ALTERNATIVES TO FRENCH FRIES

(75) Inventors: Caius ROMMENS, Boise, ID (US); Mark Heap, Victoria (AU); Roshani Shakya, Boise, ID (US)

Correspondence Address: FOLEY AND LARDNER LLP;SUITE 500, 3000 K STREET NW, WASHINGTON, DC, 20007, US

(73) Assignee: J.R. Simplot Company

(21) Appl. No.: 12/779,864

(22) Filed: May 13, 2010

Related U.S. Application Data
(60) Provisional application No. 61/178,275, filed on May 14, 2009.
(60) Provisional application No. 61/178,744, filed on May 15, 2009.
(60) Provisional application No. 61/228,395, filed on Jul. 24, 2009.
(60) Provisional application No. 61/241,587, filed on Sep. 11, 2009.

(51) Int. Cl. A23L 1/216; A23L 1/217; A23L 1/01; B26D 1/00

(52) U.S. Cl. 426/637; 426/518; 426/438; 426/509; 83/13

(57) ABSTRACT

The present technology concerns the creation of healthy and appealing new foods made from tubers, such as healthy French Fries, and potato rings that have low surface area-to-volume ratios than the surface area-to-volume ratio of conventional potato products.

This U.S. non-provisional application claims priority to the following U.S. provisional applications: Ser. No. 61/178,275, which was filed on May 14, 2009; Ser. No. 61/178,744, which was filed on May 15, 2009; Ser. No. 61/228,395, which was filed on Jul. 24, 2009; and Ser. No. 61/241,587, which was filed on Sep. 11, 2009, each of which is incorporated herein by reference in its entirety.

### FIELD OF THE INVENTION

The present technology concerns the creation of healthy and appealing new foods made from tubers, such as potato rings and potato strips having at least six sides, which have low surface area-to-volume ratios compared to the surface area-to-volume ratios of conventional, rectangular-shaped French fries.

### BACKGROUND

Acrylamide is a neurotoxin formed as a consequence of the low-moisture and heat-induced Maillard reaction between reducing sugars and amino acids in strips of potato tubers.

The present inventive technology provides the potato industry with healthy foods that have been processed differently and which address the issue of acrylamide accumulation on cooked potato products, such as accumulation on French fries after frying. Furthermore, the inventive healthy foods are as tasty or tastier than those processed conventionally. Thus, the inventive potato foods have similar or enhanced sensory characteristics compared to French fries. The enhanced sensory characteristics relate to, for examples, improved crispness, enhanced taste, optimized color, or new shape.

### SUMMARY

One aspect of the present invention is an uncooked potato product that is either (1) a potato strip comprising at least six sides and which has a surface area-to-volume ratio lower than the surface area-to-volume ratio of a conventional potato product that has a rectangular cross-sectional shape of the same volume and height, or (2) a potato ring, wherein the potato product has at least one equivalent or enhanced sensory characteristic compared to a conventional potato product when it is heat-processed. In one embodiment, the potato product is cut from the outer region of the potato. In another embodiment, the sensory characteristic is selected from the group consisting of texture, taste, color, and uniformity.

In one embodiment the potato product, when it is heat-processed, has low levels of at least one of acrylamide salt and oil content. In one embodiment, the uncooked potato product accumulates approximately 1-20 parts per billion (ppb), 20-40 ppb, 40-60 ppb, 60-80 ppb, 80-100 ppb, 100-120 ppb, 120-140 ppb, 140-160 ppb, 160-180 ppb, 180-200 ppb or 200-220 ppb of acrylamide when it is heat-processed compared to a potato product of the same dimensions that is cut from the inner region of the potato.

In another embodiment, the potato product has about 10% less oil content (% by weight), about 11% less oil content (% by weight), about 12% less oil content (% by weight), about 13% less oil content (% by weight), about 14% less oil content (% by weight), about 15% less oil content (% by weight), about 16% less oil content (% by weight), about 17% less oil content (% by weight), about 18% less oil content (% by weight), about 19% less oil content (% by weight), or about 20% less oil content (% by weight) than a potato product of the same dimensions that is cut from the inner region of the potato.

In another embodiment, the potato product comprises high levels of any least one of an antioxidant such as chlorogenic acid and vitamin C than a potato product of the same dimensions that is cut from the inner region of the potato.

Another aspect of the present invention is a collection of the potato products, wherein substantially all of the potato products in the collection are cut from the outer region of a potato. In one embodiment, substantially all of the potato products in the collection are either (1) strips comprising at least six sides and each of which has a surface area-to-volume ratio lower than the surface area-to-volume ratio of a conventional potato product that has a rectangular cross-sectional shape of the same volume and height, or (2) potato rings. In another embodiment, the collection comprises a mixture of (1) potato strips that have at least six sides, and (2) potato rings.

Another aspect of the present invention is a method of producing a potato product, comprising (1) cutting a strip from a potato tuber, wherein the strip has a surface area-to-volume ratio that is lower than the surface area-to-volume ratio of a strip of rectangular cross-sectional shape having the same volume and height, or (2) cutting a ring from a potato tuber, wherein the strip or ring is either (i) cut from the outer region of the potato, or (ii) cut from a potato tuber that is obtained from a recombinant potato plant that comprises a down-regulated expression of at least one of an R1 gene, phosphorylase-L gene, and an asparagine synthetase compared to the expression of that gene in a non-recombinant potato plant. In one embodiment, the potato tuber from which the potato product is cut comprises low levels of at least one of a reducing sugar and asparagine. In another embodiment, the method further comprises heat-processing the potato product by frying, deep-frying, par-frying, baking, boiling, searing, roasting, or blanching. In one embodiment, the heat-processed potato product has low levels of at least one of acrylamide, oil content, and salt after it is heat-processed.

One aspect of the present invention therefore is a potato product made from an outer region of a potato tuber. In one embodiment, the product is a French fry, or a chip, but the present invention is not limited to just these well-known potato products. In one embodiment, the product is a French fry. In one embodiment, the French fry is hexagonally shaped. That is, in one embodiment a potato product is in the shape of a linear-hexagon, like a hexagonal column. In another embodiment, the potato product is in the shape of a linear-octagon, linear-oval, or linear-circular column. These shapes refer to “strips” or “columns” of potatoes that are sliced along the length of the potato in different shapes that may or may not approximate a cylinder shaped product. A potato can be cut cross-wise, too, in various different shapes, such as in concentric circles, or concentric squares, or concentric hexagons, or in any shape. In one embodiment, these cross-wise-cut shapes are concentric meaning there is no potato flesh in the middle, thus a concentric potato slice is fashioned like a ring structure. The part of the potato that makes up the concentrically-cut potato product is therefore comprised of the outer region flesh of the potato.

In one embodiment, a French fry of the present invention, or any potato product, that is made from the outer region of the potato tuber, accumulates less acrylamide on its surface upon heat-processing than the amount of acrylamide that accumulates on a French fry of equivalent dimension made from a part of the tuber that is not the outer region. In one embodiment, the outer region of the potato tuber is the region of the potato that comprises little if any medulla tissue.

Another aspect of the present invention is a collection of French fries, wherein substantially all of the fries in the collection are cut from the outer regions of potatoes. In one embodiment, at least 80% of the French fries are cut from the outer regions of potatoes.

Another aspect of the present invention is a method for making a potato product, comprising (A) slicing a potato tuber into strips; and (B) selecting strips cut from the outer region of the potato tuber, wherein a strip cut from the outer region of the potato tuber is a potato product that will accumulate less, if any, acrylamide upon heat-processing compared to a potato strip that is not selected from the outer region of the potato tuber that is heat-processed under the same conditions. In one embodiment, the potato strip is a French fry or chip. In another embodiment, the potato strip may be cut into a non-rectangular shape, such as in the shape of a linear-hexagon, linear-octagon, linear-oval, or linear-circular column shape.

Another aspect of the present invention therefore is a method for making a potato product, comprising cutting a potato tuber into strips each of which has a surface area-to-volume ratio that is lower than the surface area-to-volume ratio of a rectangular-shaped potato tuber strip of the same dimension as the cut strip. In one embodiment, the cut strips are in the shape of hexagonal columns.

Another aspect of the present invention is a fried potato product, wherein 1 gram of the product contains a smaller amount of at least one of the group of compounds consisting of acrylamide, vegetable oil, and salt, than 1 gram of French fries that is not produced according to the present inventive methods. In one embodiment, the fried product is different from French fries in at least one sensory characteristic, such as enhanced texture, enhanced taste, enhanced color, and altered shape. Thus, in another embodiment, the sensory characteristic of the potato product comprises at least one of enhanced texture, enhanced taste, enhanced color, and altered shape.

Another aspect of the present invention is a method for making a potato product, comprising (A) slicing strips cut from the outer region of the potato tuber; and (B) heat-processing the strips to produce a fried product that contains less of at least one of the group of compounds consisting of acrylamide, vegetable oil, and salt than the fried product derived from a strip that is not selected from the outer region of the potato tuber.

Another aspect of the present invention is a fried potato product derived from a collection of potato strips with (i) a width and depth between 6 and 9-mm and (ii) a smaller surface-to-volume ratio than potato strips with a width and depth between 6 and 9-mm that are used to produce French fries.

One aspect of the present invention is a collection of potato strips, wherein the strips are not derived from any random part of the tuber flesh but wherein substantially all of the strips are derived from the outer regions of the tuber flesh. In one embodiment, at least 80% of strips are cut from the outer regions of the tuber flesh. In one embodiment, 1 gram of the potato product contains a smaller amount of at least one of the group of compounds consisting of acrylamide, vegetable oil, and salt, than 1 gram of conventionally made French fries. In another embodiment, a fried product of the present invention is different from French fries in at least one sensory characteristic, such as enhanced texture, enhanced taste, enhanced color, and altered shape.

One aspect of the present invention is a method of cutting a potato tuber, comprising: cutting at least a portion of a potato tuber with a cutting apparatus having cutting edges that define openings therebetween, to produce cut strips of the potato tuber, wherein the cutting edges are configured to define the openings such that the openings do not have a rectangular cross-sectional shape and thereby form cut strips having a surface area-to-volume ratio that is lower than the surface area-to-volume ratio of a strip of rectangular cross-sectional shape having a same volume and height.

In one embodiment, the cutting of the at least a portion of the potato tuber includes causing relative movement between the at least a portion of the potato tuber and the cutting apparatus.

In another embodiment, the relative movement between the at least a portion of the potato tuber and the cutting apparatus is caused by at least one of moving the at least a portion of the potato tuber through the cutting apparatus and moving the cutting apparatus through at least a portion of the potato tuber.

In another embodiment, the cutting edges define the openings to each have a cross-sectional shape with at least six sides.

In another embodiment, the cutting edges are each provided on an end of a substantially plate-like section, wherein the plate-like sections form tubes with the openings therebetween.

Another aspect of the present invention is a cutting apparatus for cutting a potato tuber, comprising: cutting edges that define openings therebetween, wherein the cutting edges are configured to cut at least a portion of a potato tuber to produce cut strips when the cutting apparatus is moved relative to the at least a portion of the potato tuber, wherein the cutting edges are configured to define the openings such that the openings do not have a rectangular cross-sectional shape and thereby form cut strips having a surface area-to-volume ratio that is lower than the surface area-to-volume ratio of a strip of rectangular cross-sectional shape having a same volume and height.

In one embodiment, the cutting edges define the openings to each have a cross-sectional shape with at least six sides.

In another embodiment, the cutting edges are each provided on an end of a substantially plate-like section, wherein the plate-like sections form tubes with the openings therebetween.

Another aspect of the present invention is a method of cutting a potato tuber having an inner core and an outer region, comprising: cutting at least a portion of a potato tuber with a cutting apparatus to produce cut rings, wherein the cutting apparatus has a plurality of cutting edges of substantially circular cross-sectional shape and the cutting edges have differing diameters and are concentrically disposed; and separating cut rings produced from the outer region from the inner core.

In one embodiment, the cutting of the at least a portion of the potato tuber includes causing relative movement between the at least a portion of the potato tuber and the cutting apparatus.

In another embodiment, the relative movement between the at least a portion of the potato tuber and the cutting apparatus is caused by at least one of moving the at least a portion of the potato tuber through the cutting apparatus and moving the cutting apparatus through the at least a portion of the potato tuber.

In another embodiment, the cutting apparatus cuts the at least a portion of the potato tuber in a cutting direction, and further comprising: slicing the cut rings in a direction substantially perpendicular to the cutting direction.

In another embodiment, this method further comprises slicing the potato tuber before cutting with the cutting apparatus. In another embodiment, the cut rings of the potato tuber are ejected from the cutting apparatus with a plunger having projections configured to engage the cut rings.

In one embodiment, the cutting edges are each provided on an end of a substantially cylindrical member.

Another aspect of the present invention is a cutting apparatus for cutting a potato tuber, comprising: a plurality of cutting edges of substantially circular cross-sectional shape, wherein the cutting edges have differing diameters and are concentrically disposed to cut an outer region of at least of portion of a potato tuber to form cut rings. In one embodiment, the cutting edges are each provided on an end of a substantially cylindrical member. In another embodiment, the cutting apparatus further comprises a support configured to maintain a spatial relationship between the cutting edges. In another embodiment, the cutting apparatus further comprises a plunger having projections configured to engage the cut rings to eject the cut rings.

Another aspect of the present invention comprises heat-processing any of the cut potato strips made by any of the methodological embodiments described herein. In one embodiment, the cut potato strip is heat-processed by frying, deep-frying, par-frying, baking, boiling, searing, roasting, or blanching. In another embodiment, the cut potato strip is from the outer region of the potato. In another embodiment, the cut potato strip is from the inner core of the potato.

In another embodiment, a cutting method of the present invention further comprises selecting for cutting a potato tuber that comprises lower levels of at least one of a reducing sugar and asparagine. In one embodiment, the potato tuber is obtained from a recombinant potato plant that comprises a downregulated expression of at least one of an R1 gene, phosphorylase-L gene, and an asparagine synthetase compared to a non-recombinant potato plant.

In another embodiment, the recombinant potato plant, comprises in its genome an expression cassette, wherein the expression cassette comprises a tuber-specific promoter operably linked to a polynucleotide with a sequence that is complementary to a sequence of at least one of a gene selected from the group consisting of an R1 gene, phosphorylase-L gene, and an asparagine synthetase gene. In one embodiment, the polynucleotide is operably linked to a second promoter. In another embodiment, the second promoter is a tuber-specific promoter. In another embodiment, the tuber-specific promoter and the second promoter are operably linked to either end of the polynucleotide. In another embodiment, the polynucleotide comprises inverted repeat sequences of the selected gene(s). In another embodiment, the polynucleotide has a sequence that is complementary to at least 15-500 nucleotides of the R1 gene, phosphorylase-L gene, or asparagine synthetase gene. In another embodiment, the polynucleotide is complementary to a coding region of the selected gene(s), a non-coding region of the selected gene(s), a 5′-untranslated region of the selected gene(s), 3′-untranslated region of the selected gene(s), a regulatory region of the selected gene(s), or a region of the promoter of the selected gene(s).

In one embodiment, a method of the present invention further comprises separating potato strips cut from the outer region of the potato from potato strips cut from the inner core of the potato.

Another aspect of the present invention is a collection of potato strips, wherein substantially all of the potato strips in the collection are cut from the outer region of a potato.

Another aspect of the present invention is a potato strip made from any of the methods and methodological embodiments described herein.

Another aspect of the present invention is an uncooked potato strip comprising at least six sides. In one embodiment, the potato strip accumulates a lower concentration of acrylamide when it is cooked or heat-processed. In another embodiment, the strip is cut from a potato tuber that is obtained from a recombinant potato plant that comprises a down-regulated expression of at least one of an R1 gene, phosphorylase-L gene, and an asparagine synthetase compared to a non-recombinant potato plant. In one embodiment, the recombinant potato plant, comprises in its genome an expression cassette, wherein the expression cassette comprises a tuber-specific promoter operably linked to a polynucleotide with a sequence that is complementary to a sequence of at least one of a gene selected from the group consisting of an R1 gene, phosphorylase-L gene, and an asparagine synthetase gene.

In another embodiment, the polynucleotide is operably linked to a second promoter. In another embodiment, the second promoter is a tuber-specific promoter. In another embodiment, the tuber-specific promoter and the second promoter are operably linked to either end of the polynucleotide. In another embodiment, the polynucleotide comprises inverted repeat sequences of the selected gene(s). In another embodiment, the polynucleotide has a sequence that is complementary to at least 15-500 nucleotides of the R1 gene, phosphorylase-L gene, or asparagine synthetase gene. In another embodiment, the polynucleotide is complementary to a coding region of the selected gene(s), a non-coding region of the selected gene(s), a 5′-untranslated region of the selected gene(s), 3′-untranslated region of the selected gene(s), a regulatory region of the selected gene(s), or a region of the promoter of the selected gene(s).

In a method for cutting potato rings described herein there further may comprise the step of heat-processing a cut potato ring, wherein the heat-processed potato ring contains a lower amount of acrylamide than a heat-processed rectangular cross-sectional potato strip shape of same volume and height as the ring. In one embodiment, the potato ring is heat-processed by frying, deep-frying, par-frying, baking, boiling, searing, roasting, or blanching. In another embodiment, the potato ring is cut from the outer region of the potato. In another embodiment, the potato ring is cut from the inner core of the potato. In another embodiment, this method further comprises selecting for cutting with the apparatus a potato tuber that comprises lower levels of at least one of a reducing sugar and asparagine.

In another one, the potato tuber is obtained from a recombinant potato plant that comprises a downregulated expression of at least one of an R1 gene, phosphorylase-L gene, and an asparagine synthetase compared to a non-recombinant potato plant. In one embodiment, the recombinant potato plant, comprises in its genome an expression cassette, wherein the expression cassette comprises a tuber-specific promoter operably linked to a polynucleotide with a sequence that is complementary to a sequence of at least one of a gene selected from the group consisting of an R1 gene, phosphorylase-L gene, and an asparagine synthetase gene. In another embodiment, the polynucleotide is operably linked to a second promoter. In another embodiment, the second promoter is a tuber-specific promoter. In another embodiment, the tuber-specific promoter and the second promoter are operably linked to either end of the polynucleotide. In one embodiment, the polynucleotide comprises inverted repeat sequences of the selected gene(s).

In another embodiment, the polynucleotide has a sequence that is complementary to at least 15-500 nucleotides of the R1 gene, phosphorylase-L gene, or asparagine synthetase gene.

In another embodiment, the polynucleotide is complementary to a coding region of the selected gene(s), a non-coding region of the selected gene(s), a 5′-untranslated region of the selected gene(s), 3′-untranslated region of the selected gene(s), a regulatory region of the selected gene(s), or a region of the promoter of the selected gene(s).

Another aspect of the present invention is a collection of potato rings, wherein substantially all of the potato strips in the collection are cut from the outer region of a potato.

Another aspect of the present invention is a potato ring made from any of the cutting methods and methodological embodiments described herein.

Another aspect of the present invention is an uncooked potato ring that accumulates lower amount of acrylamide than a rectangular cross-sectional potato strip of the same volume and height as the ring, when the ring is heat-processed. In one embodiment, the potato ring is heat-processed by frying, deep-frying, par-frying, baking, boiling, searing, roasting, or blanching. In another embodiment, a potato tuber from which a potato ring is cut comprises lower levels of at least one of a reducing sugar and asparagine. In one embodiment, the potato tuber is obtained from a recombinant potato plant that comprises a downregulated expression of at least one of an R1 gene, phosphorylase-L gene, and an asparagine synthetase compared to a non-recombinant potato plant. In another embodiment, the recombinant potato plant, comprises in its genome an expression cassette, wherein the expression cassette comprises a tuber-specific promoter operably linked to a polynucleotide with a sequence that is complementary to a sequence of at least one of a gene selected from the group consisting of an R1 gene, phosphorylase-L gene, and an asparagine synthetase gene. In another embodiment, the polynucleotide is operably linked to a second promoter. In another embodiment, the second promoter is a tuber-specific promoter. In another embodiment, the tuber-specific promoter and the second promoter are operably linked to either end of the polynucleotide. In another embodiment, the polynucleotide comprises inverted repeat sequences of the selected gene(s). In another embodiment, the polynucleotide has a sequence that is complementary to at least 15-500 nucleotides of the R1 gene, phosphorylase-L gene, or asparagine synthetase gene. In another embodiment, the polynucleotide is complementary to a coding region of the selected gene(s), a non-coding region of the selected gene(s), a 5′-untranslated region of the selected gene(s), 3′-untranslated region of the selected gene(s), a regulatory region of the selected gene(s), or a region of the promoter of the selected gene(s).

### BRIEF DESCRIPTION OF THE DRAWINGS

FIG. 1. Longitudinal (A) and latitudinal (B) diagram of a potato tuber. Areas shown in lighter gray shades contain more water and less dry matter than those in darker tones. The grid in FIG. 1B indicates a pattern of a conventional knife system designed to produce potato strips. An “inner” strip is derived from the central part of the tuber whereas an “outer” strip is from more peripheral parts.

FIG. 2. Moisture content of inner (“In”) and outer (“Out”) strips. Asterisks indicate statistically-significant differences (P<0.05).

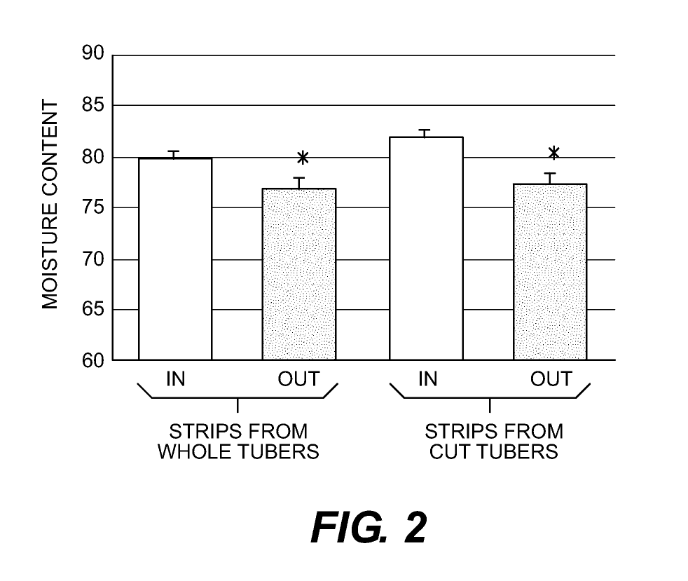

FIG. 3. Moisture content of inner (“In”) and outer (“Out”) French fries. Asterisks indicate statistically-significant differences (P<0.05).

FIG. 4. Oil content of French fries from inner and outer parts of potato tubers.

FIG. 5. Biochemical analysis of strips and fries from various parts of potato tubers. (A) Asparagine levels in strips, (B) amounts of glucose and fructose in strips, (C) processing-induced acrylamide levels, (D) amounts of vitamin C (black bars) and chlorogenic acid (gray) in strips.

FIG. 6. Ring strips. (A) Overview of process of generating rings through slicing and cutting, (B) ring fries, (C) oil content of ring fries versus linear fries, (D) salt content of ring and linear fries.

FIG. 7. Biochemical analysis of potato rings and ring fries. (A) asparagine levels of inner strips versus ring strips, (B) amounts of glucose gray bars) and fructose (black) in inner strips compared to potato rings, (C) accumulated acrylamide in inner fries and ring fries, (D) amounts of vitamin C (black bars) and chlorogenic acid (gray) in rings and strips.

FIG. 8. Calculated average recovery rate for ring strips from Russet Burbank potato tubers with a specified minimum diameter. Tubers with a diameter below 48 mm cannot be used for the rings described in this paper.

FIG. 9. Total amino acid and protein content of inner and outer tuber tissues.

FIG. 10. large and small rings before (up) and after (down) processing.

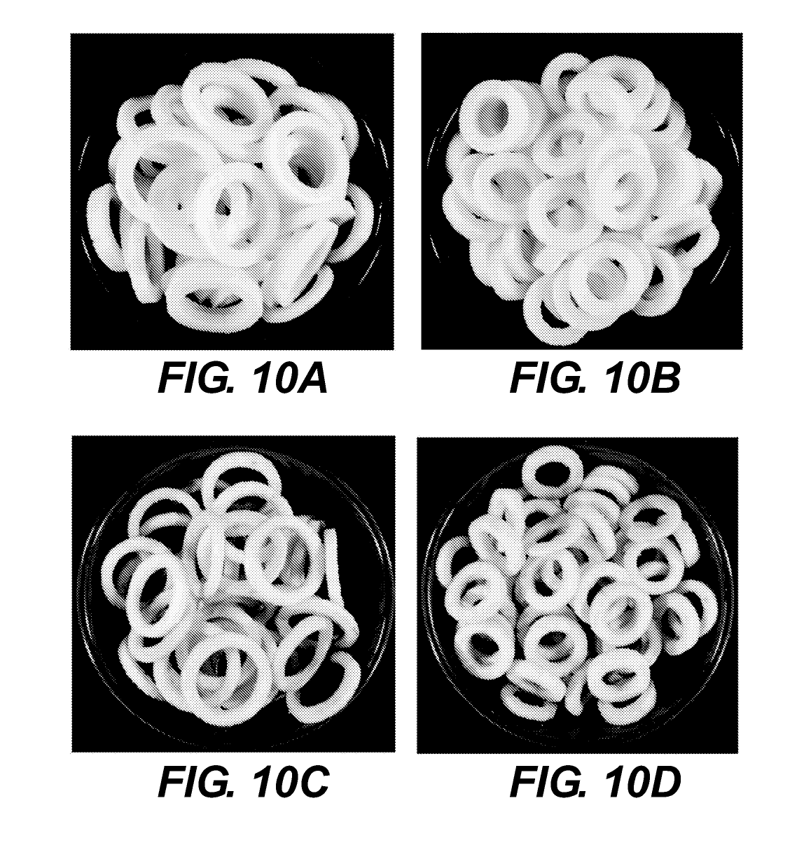

FIG. 11. A conveying device for transporting potato products to a cutting apparatus according to a second embodiment. FIG. 11A shows a top view of the conveying device, and FIG. 11B shows a side view of the conveying device.

FIG. 12. Overview of process of generating rings through cutting and slicing. (A) Cutting of potato product using a cutting apparatus according to a third embodiment. (B) Ejecting cut rings from the cutting apparatus. (C) Slicing the cut rings.

FIG. 13. Shape of hexagon fries.

FIG. 14. A side view of a cutting apparatus according to a first embodiment.

FIG. 15. Phenotype of fries from outer and inner potato tissues.

FIG. 16. Example of Idaho Sushi.

FIG. 17. A smaller cutting apparatus according to the second embodiment (without a plunger). (A) Side cross-sectional view. (B) Bottom view.

FIG. 18. A plunger for the smaller cutting apparatus according to the second embodiment. (A) Side cross-sectional view. (B) Top view.

FIG. 19. Operation of the plunger in the cutting apparatus, as shown in FIGS. 17 and 18. (A) Side cross-sectional view of plunger in operational position. (B) Side cross-sectional view of plunger in withdrawn position. (C) Bottom view of plunger in operational position.

FIG. 20. A larger cutting apparatus according to the second embodiment (without a plunger). (A) Side cross-sectional view. (B) Bottom view.

FIG. 21. A plunger for the larger cutting apparatus according to the second embodiment. (A) Side cross-sectional view. (B) Top view.

### DETAILED DESCRIPTION

The presently described inventive technologies are useful for making new food products from potato tubers that are healthier than conventional potato products made by current food processing techniques. The new foods are healthier because among other things they are low in acrylamide, oil, and salt, and have superior taste and enhanced sensory characteristics, such as taste, appearance, texture, color, aroma, and appeal, compared to existing tuber food products. Conventional potato products include but are not limited to rectangular shaped French fries, such as those available in restaurants, fast food establishments, and grocery stores, e.g., as frozen or oven-ready fries. It is understood that consumers, manufacturers, and those in the food industry in the United States use the term “French fry” or “fries,” whereas elsewhere, such as in the United Kingdom and Europe, the term “chips” is often applied to the same edible food product. The present inventive technology applies to all potato products regardless of terminology and thus applies equally to “fries” and “chips.” Accordingly, the use of any particular expression of this type of food product, e.g., fries vs. chips, in the following text is not meant to be limiting.

The inventive new foods are produced by new methods of food processing described herein. One method creates potato products, such as potato rings or strips that have at least six sides (e.g., “Hexagonal Fries,” see Example 4). In one embodiment, these potato products are made from the outer regions of potato flesh, which are low in sugars and amino acids (which would otherwise react to form acrylamide upon heating as explained below). In one embodiment, these potato products have low surface-to-volume ratios compared to conventional rectangular products. The amount of acrylamide, salt, and oil per volume of a heat-processed potato product, such as French fries, is positively correlated with the surface of this product. Thus, the inventive potato products, which have a low surface area will accumulate less acrylamide, salt, and oil compared to products with higher surface areas, such as those presently and conventionally available.

One surprising discovery of the present technology is that the outer region of a potato tuber, in contrast to the inner region, contains lower amounts of precursor sugars and amino acids, such as asparagine, that normally combine to produce carcinogenic acrylamide when heated. Another surprising discovery is that the inner core region of a potato tuber is rich in proteins and amino acids. See Table 1 below.

Accordingly, these discoveries underlie one embodiment of the present invention, namely the processing only the outer regions of potato tubers so that the resultant food product has naturally low concentrations of sugars and low concentrations of amino acids. This means that when these new food products are cooked and heated, such as by frying, significantly less acrylamide is made in and on the product because, surprisingly, the outer regions of the potato have herein been found to contain lower concentrations of the precursor sugars and amino acids that react to form acrylamide.

Acrylamide is dangerous because it is a carcinogenic neurotoxin that has recently been recognized by various State legislatures as warranting regulation. See for instance California's Safe Drinking Water and Toxic Enforcement Act of 1986, commonly known as Proposition 65. Similarly, the U.S. Food an Drug Administration has accumulated data concerning levels of acrylamide in common foods. See www.cfsan.fda.gov/˜dms/acrydata. html. That report indicates that a typical French fry produced at a restaurant of a large fast food chain contains more than 100 parts-per-billion (ppb) acrylamide. The average amount of acrylamide in such a typical French fry is 404 ppb, and the average daily intake levels of acrylamide through consumption of French fries is 0.07 microgram/kilogram of bodyweight/day. Consequently, French fries represent 16% of the total dietary intake of acrylamide. The average amount of acrylamide in oven-baked French fries and potato chips produced by a commercial processor are 698 ppb and 597 ppb, respectively. Thus, potato-derived processed foods including French fries, over-baked fries, and potato chips represent 38% of the total dietary intake for acrylamide. See also Rommens et al., Low-acrylamide French fries and potato chips, Plant Biotechnol. J., 6(8):843-853 (October 2008), which is incorporated herein by reference.

According to the present invention, the level of acrylamide that is present in a tuber product made, using conventional processing methods, from the outer region of the tuber, such as a French fry, baked fry, or chip, is lower than the level of acrylamide in a French fry, baked fry, or chip that has is processed to have the same color as the fry from the outer region but is obtained from the inner region of the potato tuber by about: 1.5-fold, 2-fold, 2.5-fold, 3-fold, 4-fold, 5-fold, 6-fold, 7-fold, 8-fold, 9-fold, 10-fold, or more than 10-fold, lower in acrylamide.

In terms of parts per billion, a potato tuber product produced using conventional processing methods from the outer region of a potato tuber may have an acrylamide level between 1-20 ppb, 20-40 ppb, 40-60 ppb, 60-80 ppb, 80-100 ppb, 100-120 ppb, 120-140 ppb, 140-160 ppb, or 160-180 ppb acrylamide. Likewise, in terms of parts per billion, a oven-baked fry, potato chip, or hash brown produced from a tuber of the present invention may have between 1-20 ppb, 20-40 ppb, 40-60 ppb, 60-80 ppb, 80-100 ppb, 100-120 ppb, 120-140 ppb, 140-160 ppb, 160-180 ppb, 180-200 ppb or 200-220 ppb acrylamide.

A potato tuber product made from the outer regions of the tuber has less oil content than that of a product made from the inner or core region of the tuber. Thus, an outer-made product has about 10% less oil content (% by weight), about 11% less oil content (% by weight), about 12% less oil content (% by weight), about 13% less oil content (% by weight), about 14% less oil content (% by weight), about 15% less oil content (% by weight), about 16% less oil content (% by weight), about 17% less oil content (% by weight), about 18% less oil content (% by weight), about 19% less oil content (% by weight), about 20% less oil content (% by weight) than compared to a product made from the inner region of the tuber. A product made from the outer regions of a tuber may have at least 20% less oil than a product made from the inner region of the tuber.

A potato tuber product made from the outer regions of the tuber has a higher chlorogenic acid content than that of a product made from the inner or core region of the tuber. Thus, an outer-made product has about 10% more chlorogenic acid (% by weight), about 15% more chlorogenic acid (% by weight), about 20% more chlorogenic acid (% by weight), about 25% more chlorogenic acid (% by weight), about 30% more chlorogenic acid (% by weight), about 35% more chlorogenic acid (% by weight), about 40% more chlorogenic acid (% by weight), about 45% more chlorogenic acid (% by weight), about 50% more chlorogenic acid (% by weight), about 70% more chlorogenic acid (% by weight), about 70% more chlorogenic acid (% by weight), about 80% more chlorogenic acid (% by weight), than compared to a product made from the inner region of the tuber. A product made from the outer regions of a tuber may have at least 20% more chlorogenic acid than a product made from the inner region of the tuber.

A potato tuber product made from the outer regions of the tuber has a higher vitamin C content than that of a product made from the inner or core region of the tuber. Thus, an outer-made product has about 10% more vitamin C (% by weight), about 12% more vitamin C (% by weight), about 14% more vitamin C (% by weight), about 16% more vitamin C (% by weight), about 18% more vitamin C (% by weight), about 20% more vitamin C (% by weight), about 22% more vitamin C (% by weight), about 24% more vitamin C (% by weight), about 26% more vitamin C (% by weight), about 28% more vitamin C (% by weight), about 30% more vitamin C (% by weight), about 32% more vitamin C (% by weight), than compared to a product made from the inner region of the tuber. A product made from the outer regions of a tuber may have at least 10% more vitamin C than a product made from the inner region of the tuber.

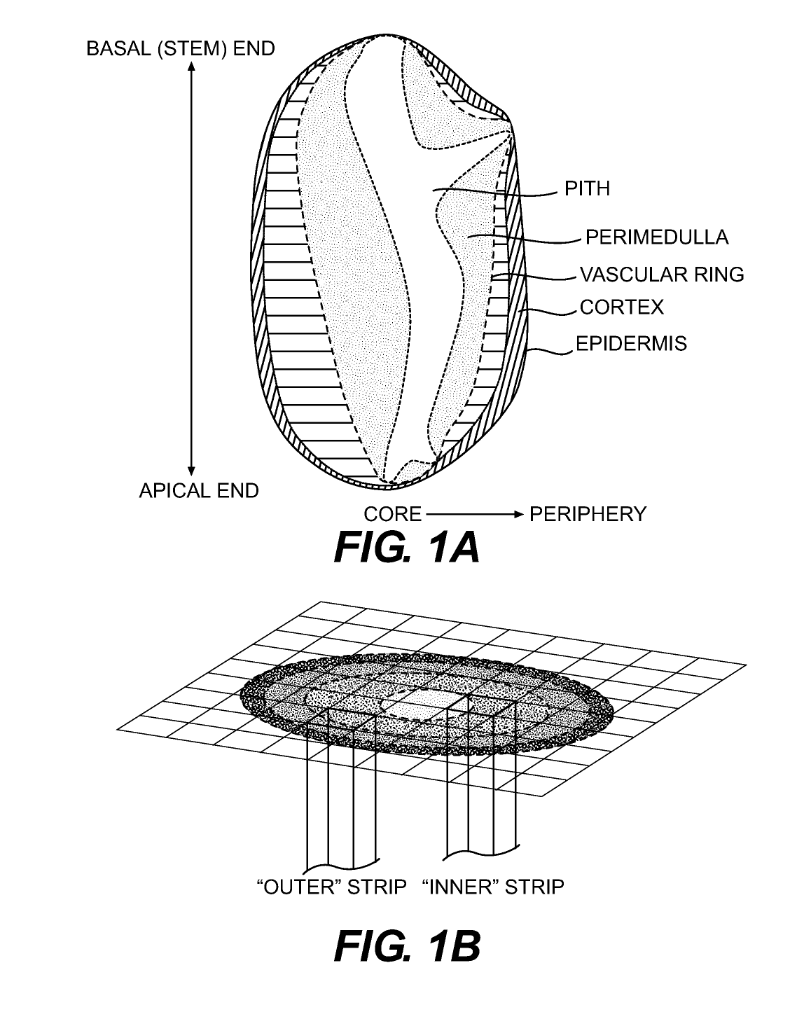

A cross-section of a potato tuber reveals the various areas of regions that are the focus of the present invention. See FIG. 1. The center mass of the potato tuber is the medulla, the primary storage area of sugars for the tuber. Surrounding the medulla is the perimedulla, another storage region in the tuber. Together the medulla and perimedulla form what is known as the parenchyma—the pith or flesh of the tuber. Surrounding this is the cortex and then two layers of skin cells known as the periderm and the outer epidermis skin cell layer. See FIG. 1. In terms of processing, the lengthwise, center strip of the cross-sectioned tuber is the “core” strip, which is predominantly comprised of the sugar storage-rich medulla. The “outer” strip contains much less if any medulla tissue. See FIG. 1. Accordingly, an “outer region” of a potato is one that contains mostly cortex tissue and hardly any medulla tissue.

It is an aspect of the present invention that processing of a tuber to yield foods made from selected outer strips of the potato tuber will contain lower amounts of sugars and amino acids that are normally concentrated in the medulla. Consequently, the lower amounts of reducing sugars (such as glucose and fructose), and amino acids (such as asparagine, glutamine, aspartate, and methionine) will produce less of the chemical, acrylamide, when the outer strip products are heated. Heat-processing includes any type of heating or cooking, such as frying, deep-frying, par-frying, baking, boiling, searing, roasting, blanching, or otherwise exposing tuber products to high temperatures.

Accordingly, one aspect of the present invention is a product made from a potato tuber that contains low amounts of reducing sugars. Reducing sugars includes but is not limited to glucose, fructose, and sucrose. By “low amounts” is meant a concentration of reducing sugars that is relatively lower than the concentration of reducing sugars from non-outer strip regions of that tuber, i.e., from the core strip. Thus, a Solanum tuberosum tuber food product of the present technology is a food that contains lower amounts of at least one reducing sugar compared to the amount of that reducing sugar in a tuber food product made from the inner, or core, regions of the tuber.

A potato tuber can be obtained from any plant that belongs to the species Solanum tuberosum. It can also be obtained from any “wild” potato, such as Solanum phureja, Solanum tuberosum subsp andigenum, Solanum demissum, and any other tuber-forming Solanum species.

Another aspect of the present invention is a product made from a potato tuber that contains low amounts of amino acids Amino acids include but are not limited to asparagine, glutamine, aspartate, and methionine. The predominant amino acid precursor acrylamide is asparagine. By “low amounts” is meant a concentration of amino acids that is relatively lower than the concentration of amino acids from non-outer strip regions of that tuber, i.e., from the core strip. Thus, a potato tuber food product of the present technology is a food that contains lower amounts of at least one amino acid, preferably asparagine, compared to the amount of that amino acid in a tuber food product made from the inner, or core, regions of the tuber.

In another aspect of the present invention is a product made from a potato tuber that contains low amounts of at least one amino acid and low amounts of at least one reducing sugar compared to the amount of that amino acid and reducing sugar in a tuber food product made from the inner, or core, regions of the tuber. As mentioned above, an amino acid includes but is not limited to asparagine, glutamine, aspartate, and methionine; and a reducing sugar includes but is not limited to glucose and fructose.

According to the present technology, any one of the aforementioned “outer” region tuber products which contains low levels of reducing sugars, amino acids, or both, can be cooked or heat-processed. The resultant concentration of acrylamide in that heat-processed product is lower than the concentration of acrylamide produced by the heat-processing of tuber products made from inner or other areas of the tuber flesh. Thus, an aspect of the present invention is a tuber food product that contains low levels of acrylamide compared to the level of acrylamide produced after heat-processing of a tuber product made from the inner or “core” regions of the tuber.

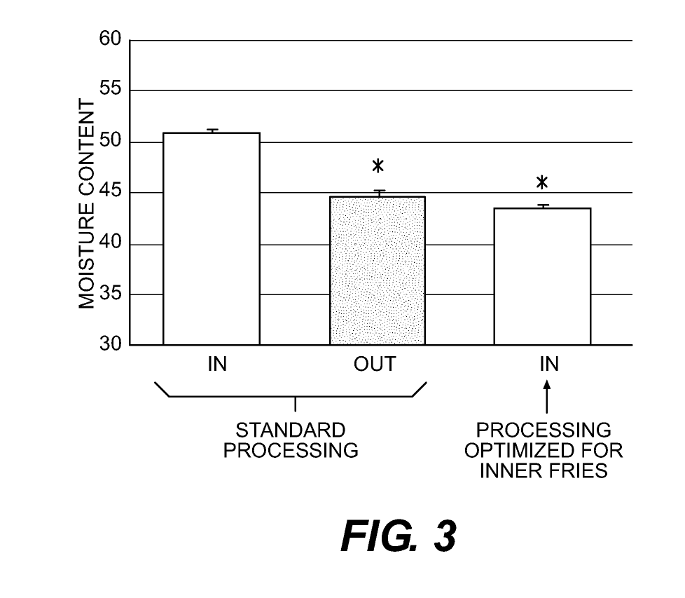

A method of the present invention includes a process of cutting tubers into cross-sectional slices with concentric blades, which yield a tuber potato “ring.” See FIG. 3. The central part of the sliced potato that is “cut-out” contains the tuber's parenchyma flesh which is rich in reducing sugars and amino acids. Because this part is cut away from the potato ring structure, the remaining flesh of the ring is low in reducing sugars and amino acids. Consequently, heat-processing of the potato ring will produce low levels of acrylamide.

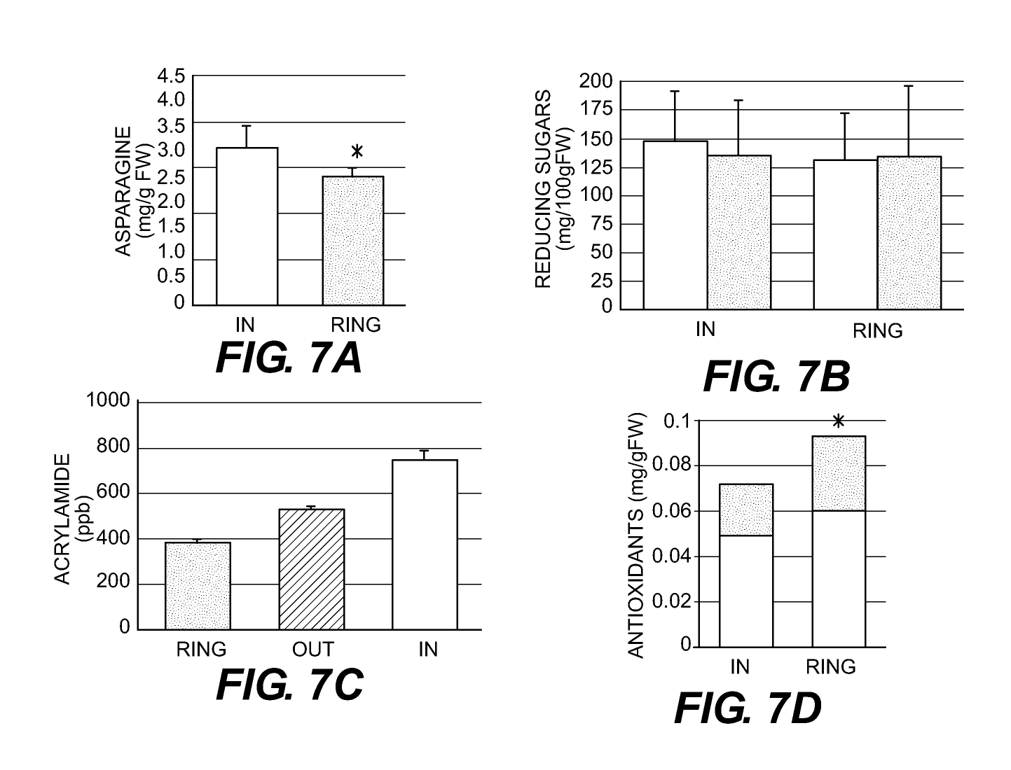

The potato products made from the embodiments of the inventive cutting apparatus contain low amounts of reducing sugars and amino acids. Consequently, heat-processing of the potato ring will produce low levels of acrylamide. It also has been found herein that the oil content of French fries made from the outer strips of a potato tuber contain about 14% less oil than fries produced from the inner core strips of the same potato tuber. See FIG. 7.

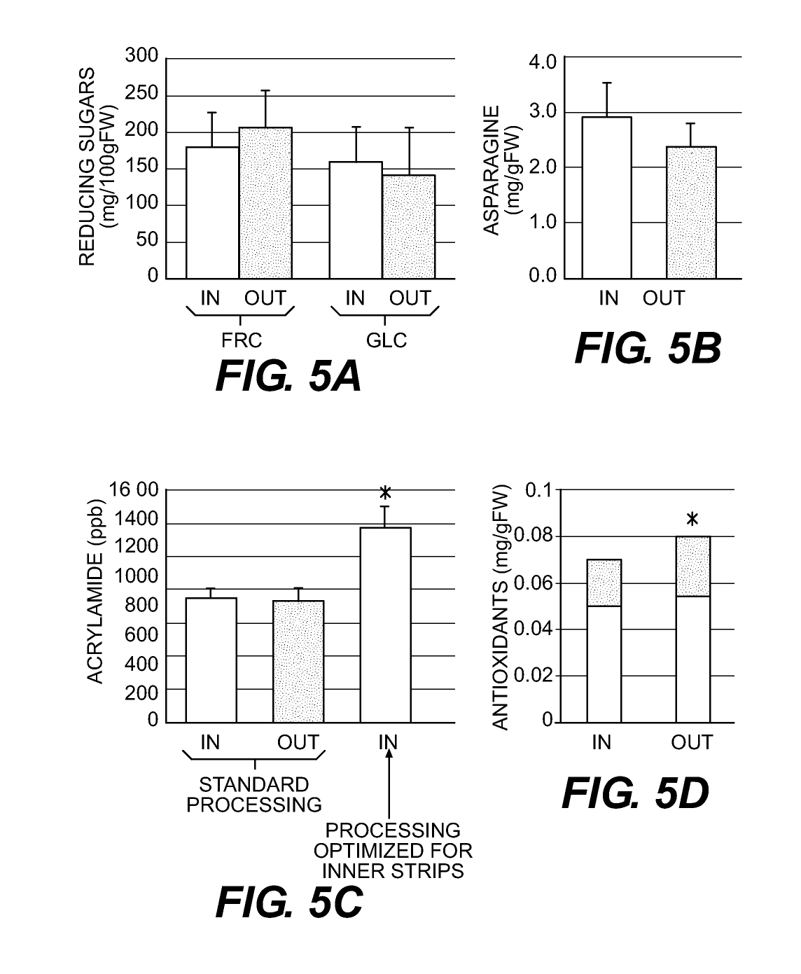

Collectively, these differences have been found to lead to differences in sensory characteristics between the outer-made and inner-made fries. A sensory-evaluation food panel determined that the outer fries are much crispier, have a better “bite,” the right “mealy” inside, a better caramel-fry taste, and have a better overall flavor. See FIG. 5.

Thus, food products made from the outer regions of a potato tuber, such as the inventive potato rings (known herein as “Omega Fries”), or slices made from the tuber's outer region are encompassed by the present invention and are healthier alternatives than products made from the inner regions of the potato tuber.

As mentioned, a surprising discovery of the present invention is the finding that the inner core of a potato tuber contains high levels of protein and amino acids. This makes the inner core a highly desirable source of foods such as mash potatoes and dehydrated food products, which contain little if any acrylamide because the method of heat-processing does not involve high temperature frying in a low-moisture environment. Accordingly, an aspect of the present invention—in addition to the production of fries from the outer region of a potato—is the production of mash potato and other high protein-containing potato products from the inner core region of the potato.

As mentioned above, another aspect of the present invention is a potato tuber food product that has a low surface-to-volume ratio. A food product that has a low surface area relative to its volume will accumulate less salt, acrylamide, and salt than a product with a larger surface area.

The dimensions of a typical French fry, of the typical rectangular prism shape, typically ranges from about 6-8 mm (width)×6-8 mm (depth)×4-12 cm (length). The surface area and volume of a rectangular prism can be determined according to the formulas:

Surface area=2(depth−height)+2(height−width)+2(depth−width)

Volume=width−depth−length

Assuming a size of 7 mm×7 mm×10 cm, then the surface area, including top and bottom, is about 29.0 cm², and the volume is 4.9 cm³. This means that the surface-to-volume (STV) ratio of a French fry is 5.92. Simply increasing the width and depth (i.e., the volume) of a potato strip is not a satisfactory solution because it will lower the sensory characteristics of the final product. A cylindrically-shaped product, however, of the same volume (4.9 cm³) and height, e.g., a diameter of 7.9 mm and length of 10 cm has a smaller surface area. The surface area and volume of a cylinder can be determined according to the formulas:

Surface area=2(π·r²)+2(π·r)·height

Volume=π·r²·height

Accordingly, the surface area is about 25.8 cm². This means that the STV ratio of a cylindrical French fry is 5.27. The cylindrically-shaped product has approximately 4.2 cm² (=11%) less surface area compared to the conventional rectangularly-shaped food product, while maintaining a similar volume and height. The cylindrical fry will not be perceived as inferior to the French fry but, instead, as a fun and unexpected alternative that is healthier as well.

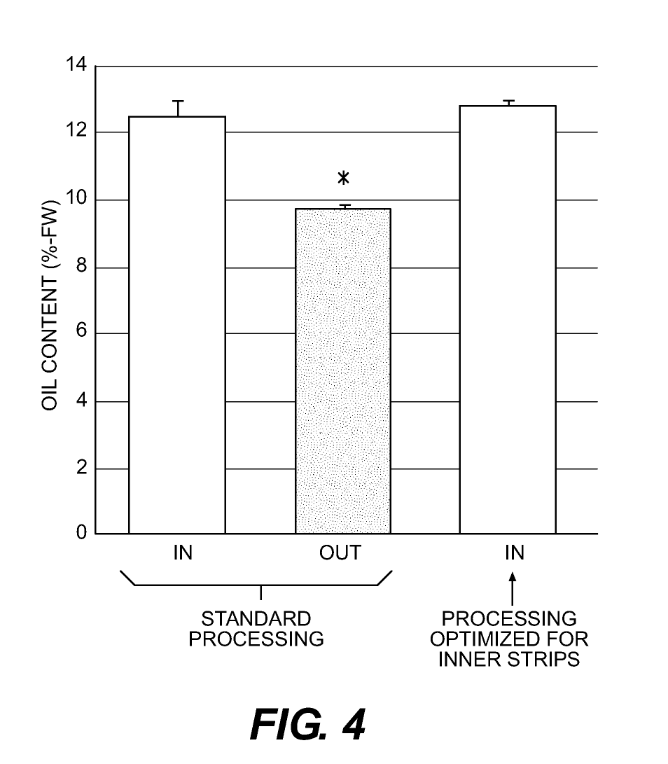

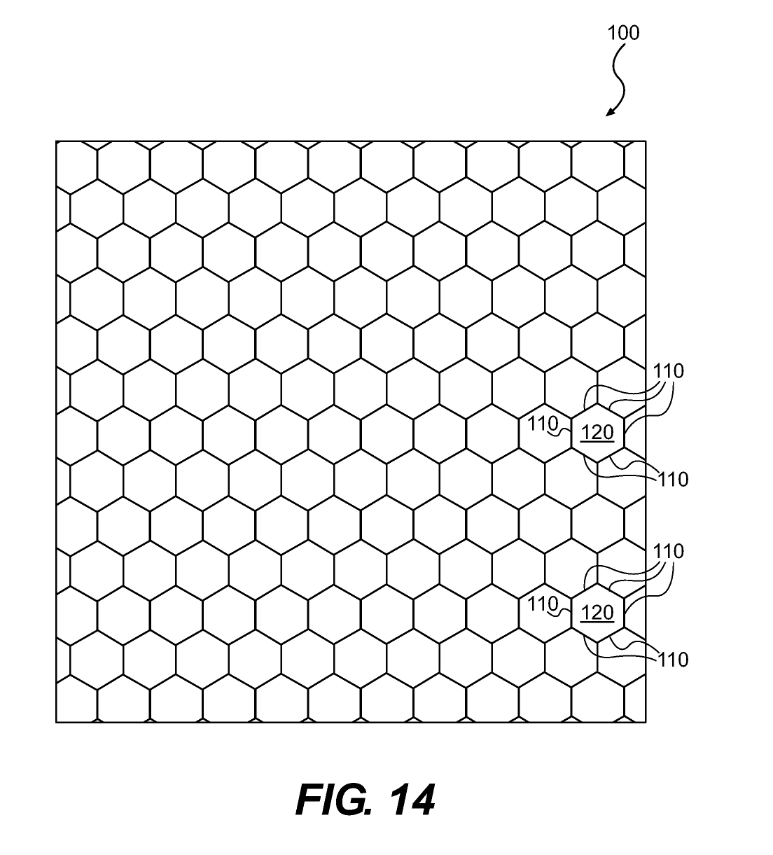

The present invention, therefore, encompasses potato tuber food products made in shapes that have a lower surface area than typical products. While a cylindrical shape is preferred based on its reduction of surface area, other shapes could be utilized that reduce surface area. One such shape is a three-dimensional hexagonal potato product, known as an hexagonal fry. See FIG. 4. A hexagonal fry has less surface area than a conventional rectangular fry. Accordingly, the hexagonal fries of the present invention will have less surface area upon which unhealthy substances such as acrylamide, salt, and oil can accumulate. Hexagonal shaped potato slices can be made using a series of zigzagged knife blades, such as those depicted in FIG. 14. The present invention is not limited to producing such shapes from only potato tubers. Other types of alternative fries have, for instance, octagonal or pentagonal shapes.

It is also possible to produce circular rings. One example of a circular ring has the shape of an “inner tube” or “torus.” The surface area and volume of a torus can be determined according to the formulas:

Surface area=4·π²·r·R

Volume=2·π²·R·r²

Thus, a torus fry with a volume of 4.9 cm³, a diameter of 7.9 mm, and a distance from the center of the tube to the center of the torus of 1.59 cm has a surface of 24.79 cm², which is 85.5% of the surface of a 4.9 cm³ French fry. The actual difference is greater because torus fries would have a standard size but French fries are variable in size and often smaller than 10-cM. Thus, two torus rings with a combined volume of 4.9 cm³ would need to be compared with three French fries with an average size of 6.67-cM. This difference is 15.9%. Because torus fries have a low surface-to-volume ratio and are derived from the outer tissues of a potato, they will have much less oil and acrylamide than French fries and they will also appear and taste better. The difference in oil and acrylamide will be about 30%.

The surface of a ring strip (for instance, a hollow cylinder with a depth and width of 7 mm) can be calculated with programs such as accessible at www.mathepower.com/english/zylinder.php. Basically, one needs to calculate the total surface of a cylinder, subtract the total surface of the core cylinder that is removed, and add the lateral surface of the core cylinder. Given an altitude of 0.7 cm, a cylinder with a radius of 1.94 cm would have a volume of 8.277 cm³ and a total surface of 32.18 cm². The smaller cylinder with radius of 1.94−0.7=1.24 cm would have a volume of 3.381 cm³ and a total surface of 15.115 cm². The lateral surface of this smaller cylinder is 5.454 cm². Thus, the total surface of a ring strip with altitude of 0.7 cm (and volume of 8.277−3.381=4.9 cm³) is 32.18−15.115+5.454=22.519 cm², which is 78% of that of a linear strip. The STV ratio of the ring strip is 4.60.

A ring strip that has a shorter depth and width, for instance 6×6 mm, but the same volume as the 7×7 rings strip described above will have a lower surface to volume ratio. This thinner ring strip must have a bigger radius. The cylinder would have a radius of 2.5 cm, and the smaller cylinder that is removed would have a radius of 1.9 cm. In this case, the surface of the ring strip is 48.695−29.845+7.163=26.01 cm². The STV ratio is, in this case, 5.23.

The present invention is not limited to any particular parameters for size of the potato product, such as ring strip, cylinder, or hexagonal fries.

Another aspect of the invention combines (1) the exclusive use of the outer regions of a tuber, and (2) new shapes of fried potato products that display a lower surface-to-volume ratio as conventional French fries, whereby the products have a much lower level of acrylamide, salt, and/or oil than a similar amount (in weight) of French fries.

### Embodiments of a Cutting Apparatus

Presently described are embodiments of a cutting apparatus for producing potato products in which (1) the STV ratio is in a preferable range and/or (2) the core or central part of a potato tuber has been removed. The present invention is not limited to these particular embodiments, which are merely examples of the types cutting apparatus and systems that can be used to produce the inventive potato rings. The present invention is not limited to the specific numerical dimensions described herein.

### First Embodiment of a Cutting Apparatus

A first embodiment of a cutting apparatus 100 according to the present invention can be configured to reduce the STV ratio of cut portions of a material, such as a potato tuber. As shown in FIG. 14, the cutting apparatus 100 preferably includes cutting edges 110 that define openings 120 therebetween. In FIG. 14, only two sets of the many cutting edges 110 and openings 120 are labeled with reference numerals.

The cutting edges 110 are configured to cut at least a portion of a potato tuber to produce cut strips when the cutting apparatus is moved relative to the at least a portion of the potato tuber. The cutting edges 110 are configured to define the openings 120 such that the cross-sectional shape of the openings 120 (the shape seen in FIG. 14) is not rectangular. Each of the sets of cutting edges 110 and openings 120 form a cut strip having a surface area-to-volume ratio that is lower than the surface area-to-volume ratio of a strip of rectangular cross-sectional shape having a same volume and height.

A single cutting edge 110, such as a cutting edge 110 with circular cross-sectional shape, can provide the desired opening 120 that will produce a cut strip with a STV ratio that is lower than the STV ratio of a rectangular-shaped strip having the same volume and height. It is preferred, however, that multiple cutting edges 110 are provided to define each opening 120 to have a six-sided (hexagonal) shape. Although additional cutting edges 110 could be utilized, as in the case of an eight sided (octagonal) shape, it is preferred to use a hexagonally shaped openings 120 because they will not leave gaps across the face of the cutting apparatus 100 that may result in material waste.

The cutting edges 110 could be provided by wires that are meshed together to form the openings 120. It is preferred, however, that the cutting edges 110 are provided at the ends of elongated members. For example, a single cutting edge 110 can be provided at the end of a cylinder (in the case of a cylindrical cutting edge). Alternatively, a plurality of cutting edges 110 can be provided on respective ends of a group of substantially plate-like sections (in the case of multi-sided openings, as shown in FIG. 14). The cylinder or group of plate-like sections will form a tube having the respective opening 120 therein. As a further alternative, the plate-like sections can be formed by laser cutting the openings 120 into a plate of metal.

In the embodiment having multi-sided openings with cutting edges 110 disposed on plate-like sections, the plate-like sections 110 can be individual members connected together or could be a portion of a larger sheet that is configured to create the network of openings 120.

The cutting apparatus 100 can cut the potato tuber by causing relative movement between the potato tuber and the cutting apparatus 100. For example, the potato tuber can be forced through the cutting apparatus 100 by any conventional processes known in the art. Alternatively, the cutting apparatus 100 can be moved such that it is forced through a stationary potato tuber.

### Second Embodiment of a Cutting Apparatus

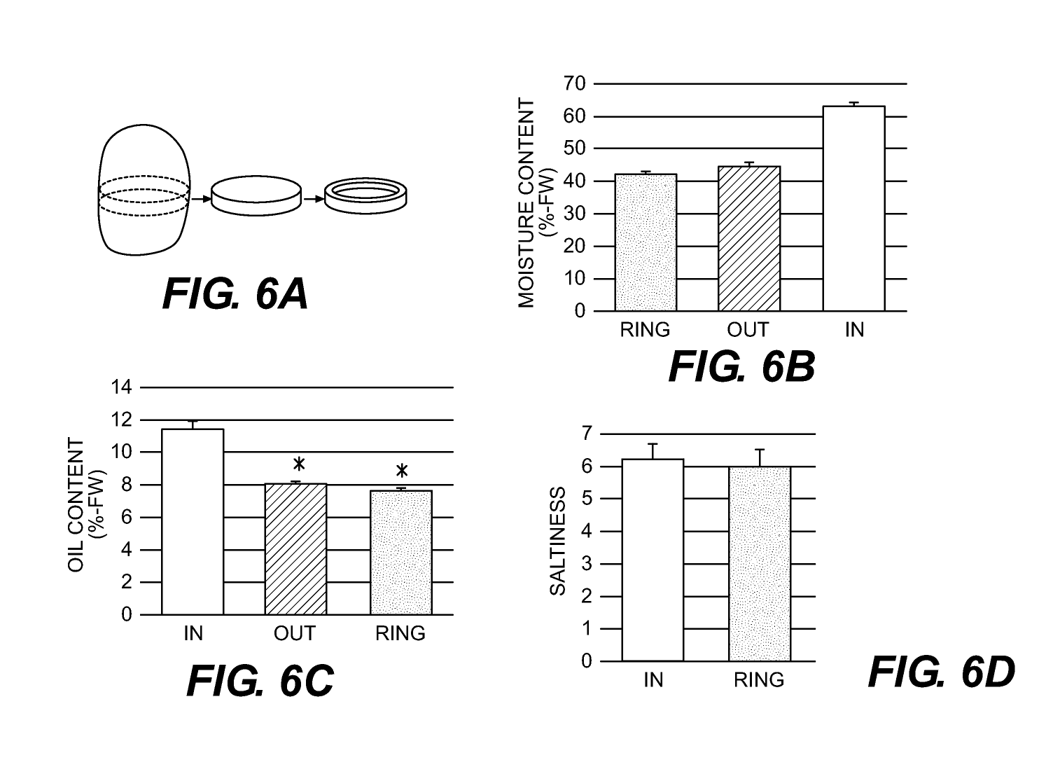

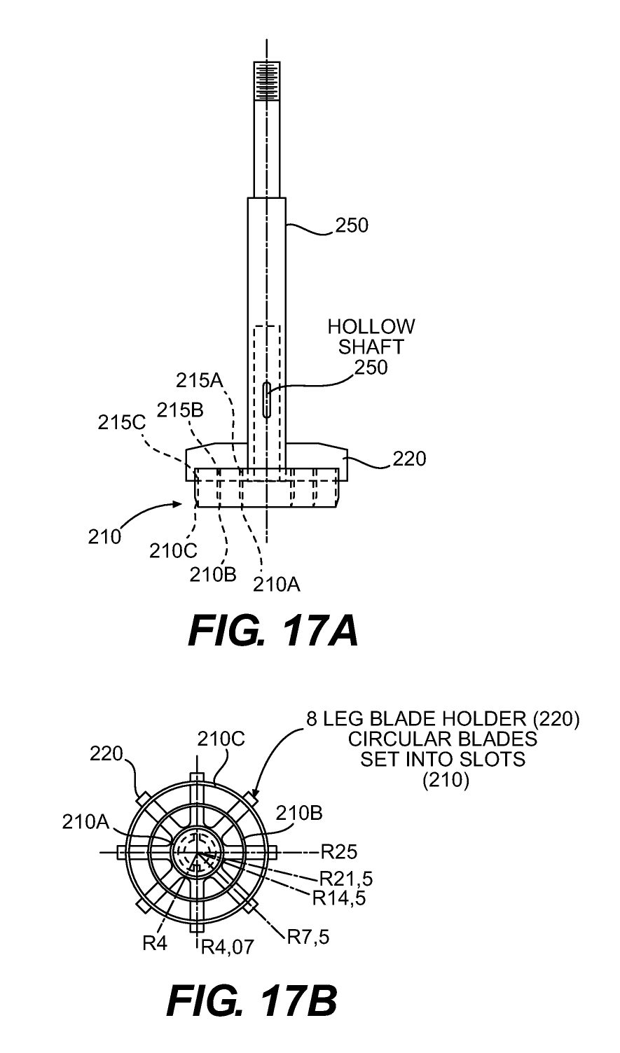

As shown in FIGS. 17-21, a second embodiment of a cutting apparatus 200 according to the present invention can be configured to produce cut rings from an outer region of a potato tuber. In this second embodiment, the cutting apparatus 200 is preferably used on portions of a potato tuber, such as discs that have been pre-sliced from the potato tuber, as shown in FIG. 6A, in a direction that is substantially perpendicular to the cutting direction of the cutting apparatus 200.

The cutting apparatus 200 preferably includes a plurality of cutting edges 210A, 210B, and 210C of substantially circular cross-sectional shape. The cutting edges 210A, 210B, and 210C have differing diameters and are concentrically disposed to cut an outer region of the potato tuber to form cut rings.

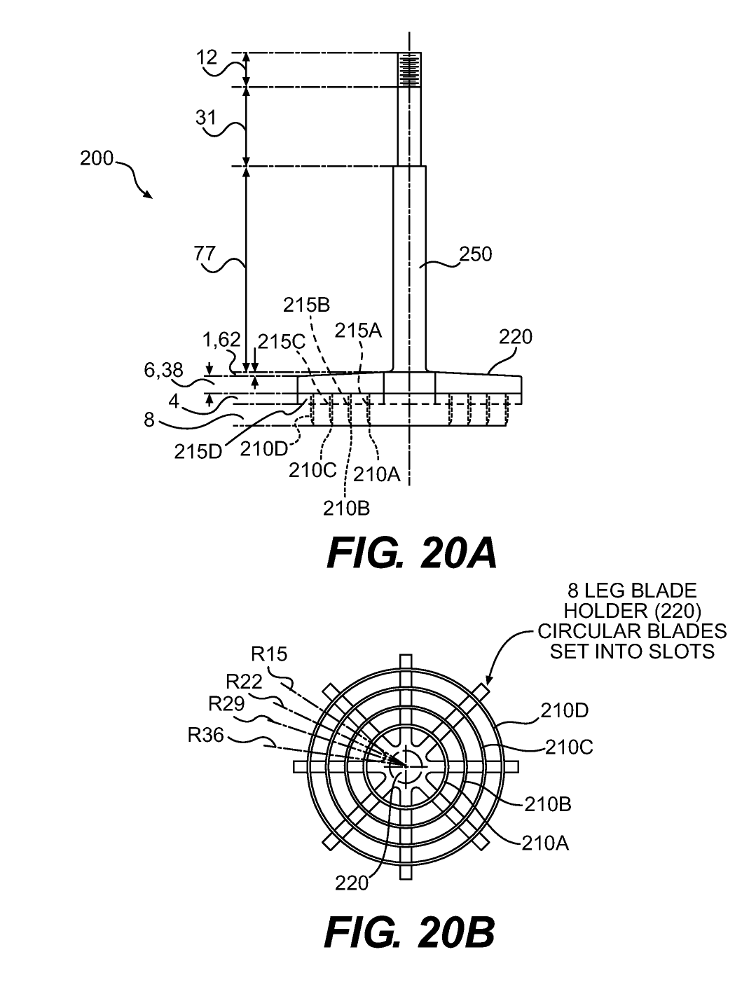

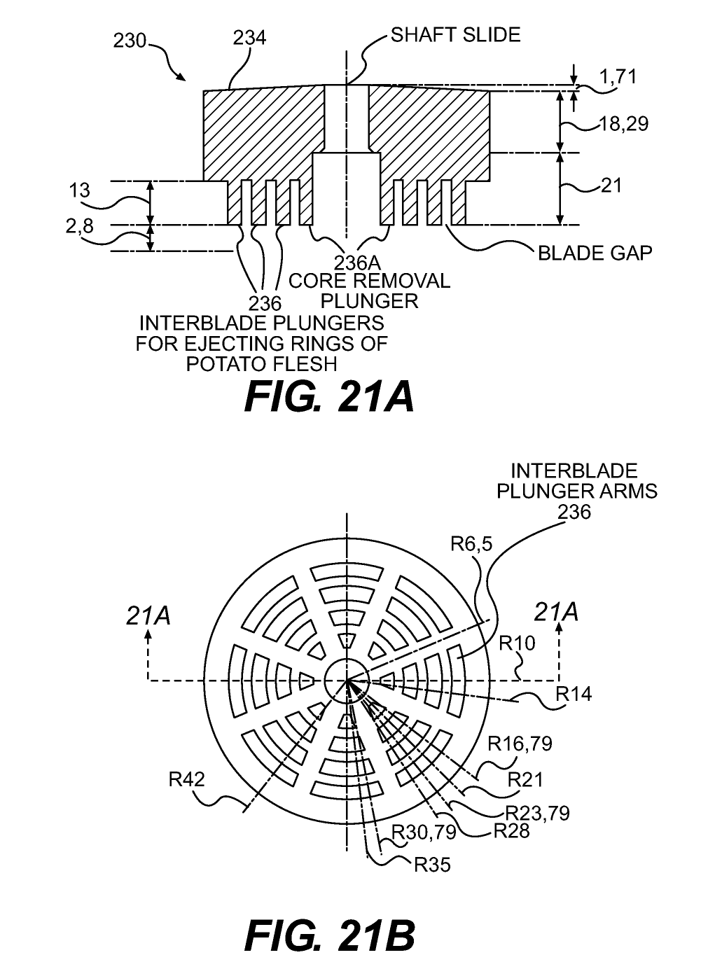

The cutting edges 210A, 210B, and 210C can each be provided on an end of a respective substantially cylindrical member 215A, 215B, and 215C. The substantially cylindrical member 215A, 215B, and 215C can be set onto a support 220 configured to maintain a spatial relationship between the cutting edges 210A, 210B, and 210C. The support 220 can be mounted at a distal end of a shaft 250. The shaft 250 is hollow in FIGS. 17-19, and not hollow in FIGS. 20-21.

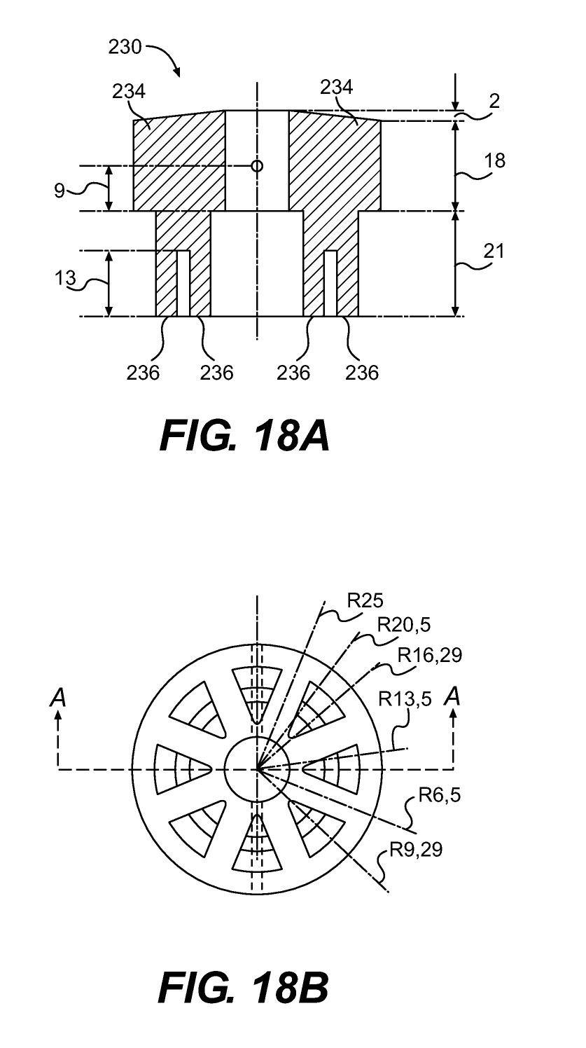

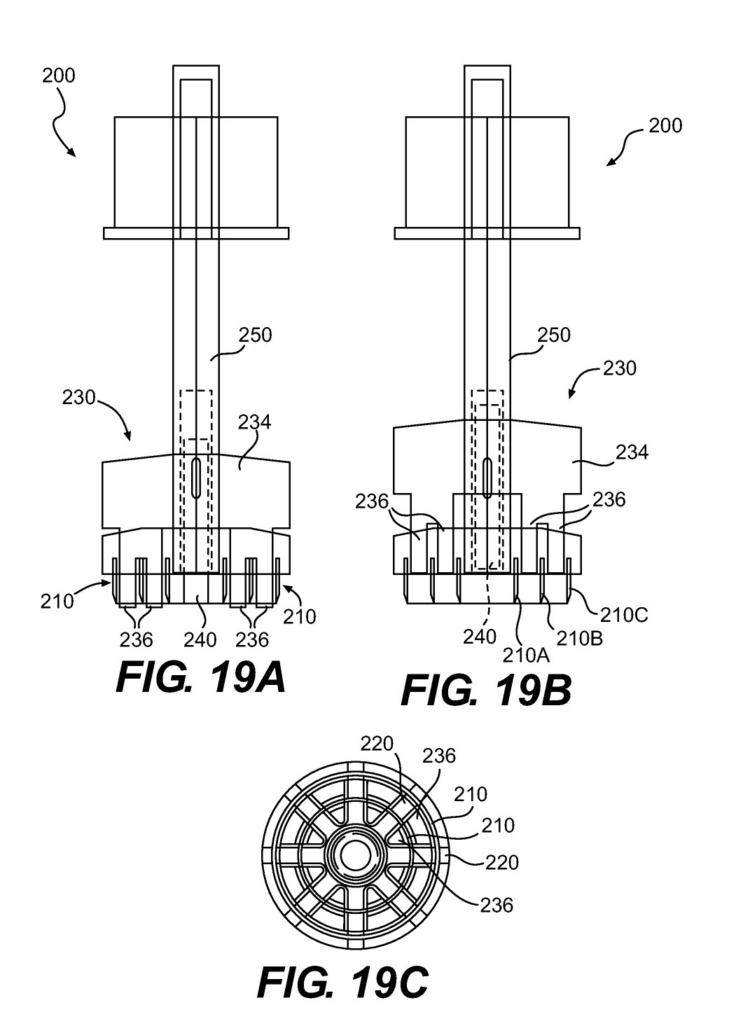

As shown in FIGS. 18-19, the cutting apparatus 200 can further include a plunger 230 having projections 236 configured to engage the cut rings to eject the cut rings from between the substantially cylindrical members 215A, 215B, and 215C. The plunger 230 can include an outer plunger body 234 that is moveably attached around a portion of the hollow shaft 250 proximal of the support 220. The projections 236 protrude distally from the outer plunger body 234. An inner plunger body 240 can also be provided and preferably is a movable central shaft fitted in the hollow shaft 250 of the cutting apparatus. A distal end of the inner plunger body 240 rests inside the hollow shaft 250 in the “up” position, but is configured to slide between the opening in the inner-most substantially cylindrical members 215A in the operational or down position. The inner plunger body 240 can be connected to the outer plunger body 234 through an opening in the hollow shaft (by a pin, for example) for simultaneous movement of the inner and outer plunger bodies 234, 240.

During operation, the cutting apparatus 200 is aligned with a pre-cut disc of potato tuber. Initially the plunger 230 is in an withdrawn or up position (meaning the projections 236 are retracted and not disposed fully between the substantially cylindrical members 215A, 215B, and 215C), as shown in FIG. 19B. In this configuration, the cutting edges 210A, 210B, and 210C can be pressed into the disc of the potato tuber cut multiple circular rings of material from an outer region and separate an inner core. After the disc is cut, the plunger 230 is moved to an operational or down position (as shown in FIG. 19A), which causes the projections 236 of the outer plunger body 234 project into openings between the substantially cylindrical members 215B, 215C and to engage the cut rings and eject them from between the substantially cylindrical members 215B, 215C. The inner plunger body 240 is also propelled distally inside the inner-most substantially cylindrical member 215A to eject the inner core. The circular rings of material produced from the cutting apparatus 200 are from the outer region of the pre-cut disc of material.

An exemplary smaller cutting apparatus is shown in FIGS. 17-19, while an exemplary larger cutting apparatus is shown in FIGS. 20-21. For use with the smaller cutting apparatus, the pre-cut discs of material are pre-cut potato discs about 7 mm thick formed from potato tubers shaped into cylinders of around 43-45 mm in diameter. The smaller cutting apparatus includes three cutting edges 210A, 210B, 210C, each formed at the end of respective substantially cylindrical members 215A, 215B, 215C having a height of 8 mm to allow cutting to a depth of 7 mm. As shown in FIG. 17, the support 220 has eight legs to position the three cutting edges 210A, 210B, 210C. Each leg of the support 220 has slots corresponding to each of the substantially cylindrical members 215A, 215B, 215C. The substantially cylindrical members 215A, 215B, 215C, thus, are set about 1 mm deep into the legs of the support 220. A first substantially cylindrical member 215A has an internal diameter of 15 mm, and is mounted onto the support 220 so that it is inner-most in the cutting apparatus 200. The first substantially cylindrical member 215A is configured to cut an inner-most portion of the potato-disc referred to as “core potato flesh”, or the “core”, which has an outer diameter of 15 mm. A second substantially cylindrical members 215B has an internal diameter of 29 mm, and is mounted on the support 220 so that is in the middle of the cutting apparatus 200. The second substantially cylindrical members 215B is configured to cut a first ring of potato flesh, such that the first ring of potato flesh is 7 mm wide and 7 mm deep and has an outer diameter of 29 mm. A third substantially cylindrical member 215C has an internal diameter of 43 mm, and is mounted on the support 220 so that it is outer-most in the cutting apparatus 220. The third substantially cylindrical member 215C is configured to cut a second ring of potato flesh, such that the second ring of potato flesh is 7 mm wide and 7 mm deep and has an outer diameter of 43 mm.

FIG. 18 shows a plunger 230 for operation with the smaller cutting apparatus. The outer plunger body 234 is shown including a pair of projections 236. Operation of both the outer plunger body 234 and inner plunger body 240 in conjunction with the smaller cutting apparatus is shown in FIG. 19. The outer and inner plunger bodies 234, 240 are raised to the “up” position for the cutting operation. In the “down” position, the outer plunger body 234 slides down to propel the projections 236 against the cut rings. At the same time, the inner plunger body 240 slides down to eject the potato core.

For use with the larger cutting apparatus, the pre-cut discs of material are pre-cut potato discs about 7 mm thick formed from potato tubers shaped into cylinders of around 72-75 mm in diameter. The larger cutting apparatus 200 includes four cutting edges 210A, 210B, 210C, 210D each formed on the ends of respective substantially cylindrical members 215A, 215B, 215C, 215D having a height of 8 mm to allow the cutting apparatus to cut to a depth of 7 mm. As shown in FIG. 20, the support 220 has eight legs to provide stability for the four substantially cylindrical members. Each leg of the support 220 has slots corresponding to each of four substantially cylindrical members. The substantially cylindrical members, thus, are set about 1 mm deep into the legs of the support 220. A first substantially cylindrical member 215A has an internal diameter of 30 mm, and is mounted onto the support 220 so that it is inner-most knife in the cutting apparatus 200. The first substantially cylindrical member 215A is configured to cut an inner-most portion of the potato-disc referred to as “core potato flesh”, or the “core”, which has an outer diameter of 30 mm. A second substantially cylindrical member 215B has an internal diameter of 44 mm, and is mounted on the support 220 so that is adjacent the first substantially cylindrical member 215A. The second substantially cylindrical member 215B is configured to cut a first ring of potato flesh, such that the first ring of potato flesh is 7 mm wide and 7 mm deep and has an outer diameter of 44 mm. A third substantially cylindrical member 215C has an internal diameter of 58 mm, and is mounted on the support 220 so that is adjacent the second substantially cylindrical member 215B. The third substantially cylindrical member 215C is configured to cut a second ring of potato flesh, such that the second ring of potato flesh is 7 mm wide and 7 mm deep and has an outer diameter of 58 mm. A fourth substantially cylindrical member 215D has an internal diameter of 72 mm, and is mounted on the support 220 so that it is outer-most knife in the cutting apparatus. The fourth substantially cylindrical member 215D is configured to cut a third ring of potato flesh, such that the third ring of potato flesh is 7 mm wide and 7 mm deep and has an outer diameter of 72 mm.

FIG. 21 shows an alternative plunger configuration for the larger cutting apparatus in which there is only an outer plunger body 234 and no inner plunger body. The outer plunger body 234 consists of four rows of projections 236 which slide into gaps between the substantially cylindrical member 215A, 215B, 215C, 215D and push out the cut rings and the inner core. The operation of the larger cutting apparatus similar to that of the small cutting apparatus, except that the shaft 250 need not be hollow and an inner plunger body 240 is not required. The inner-most projection 236A can eject the core of the cut disc, while the other projections eject corresponding circular rings of the cut disc.

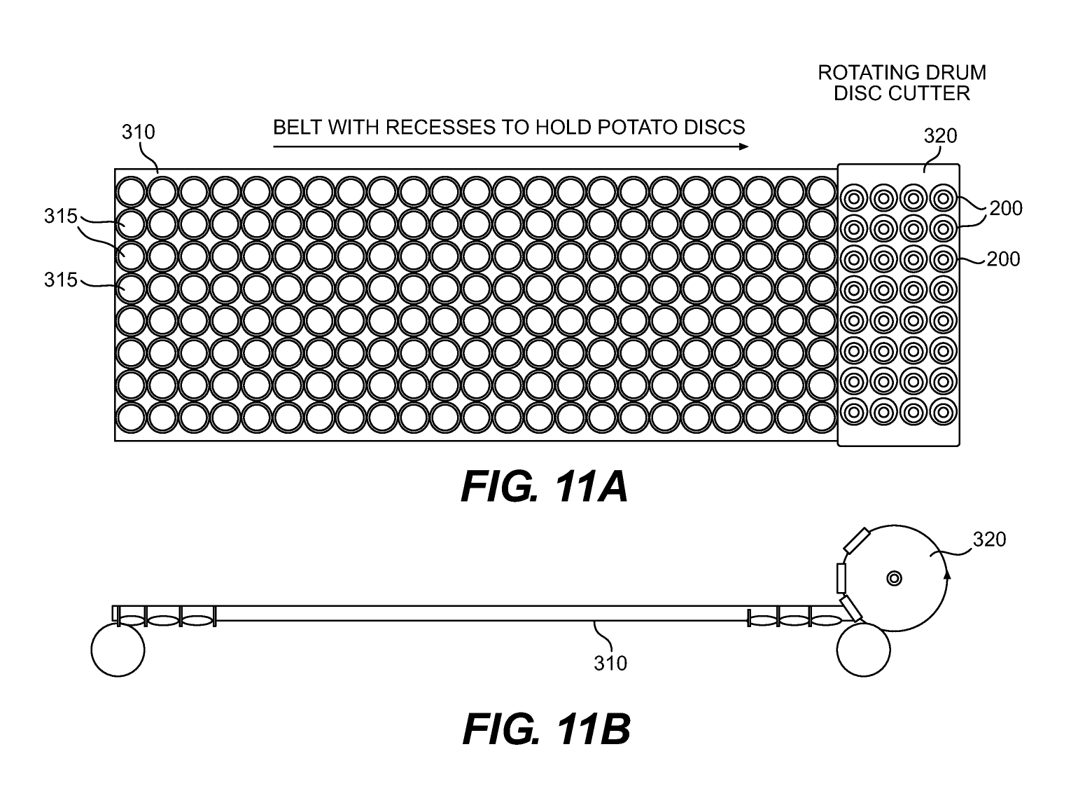

FIG. 11 shows an automated device utilizing the cutting apparatus described above. Pre-cut tuber discs are transported in rows to a rotating drum 320, which has rows of cutting apparatuses 200 disposed thereon in a number corresponding to the number of discs in each row. The transportation can be by way of, for example, a conveyor belt 310 having a plurality of recesses 315 to hold the pre-cut potato discs. Pre-cut discs having a smaller diameter are aligned with smaller cutting apparatuses, and pre-cut discs having a larger diameter are aligned with larger cutting apparatuses. The rows of cutting apparatuses 200 would spin at the same speed as the conveyor belt 310 moving underneath and a row of cutting apparatuses 200 would be propelled downward into a row of discs to perform the cutting operation. The rotating drum 320 can then continue to rotate and the plunger 230 could eject the cut rings and inner cores from the cutting apparatuses 200 and onto a separate conveyer (not shown), at which the inner cores could be separated from the cut rings by conventional means.

### Third Embodiment for a Cutting Apparatus

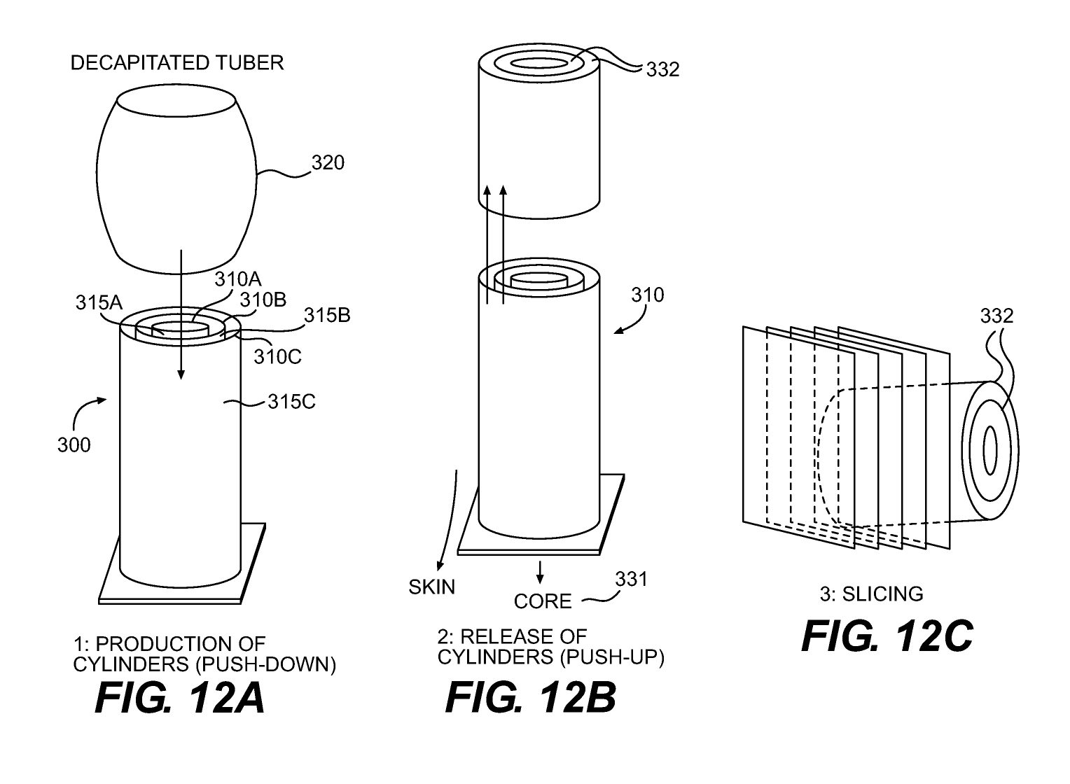

FIG. 12 shows a third embodiment of a cutting apparatus 300 according to the present invention that can be configured to produce cut rings from an outer region of a potato tuber. In this third embodiment, the cutting apparatus 300 includes a plurality of cutting edges 310A, 310B, 310C concentrically located in relation to each other. Each of the cutting edges 310A, 310B, 310C have different diameters, and are arranged inside each other such that the largest cutting edge 310C forms an exterior of the cutting apparatus 300, and the smallest cutting edge 310A forms an interior of the cutting apparatus 300. Each of the cutting edges 310A, 310B, 310C can be disposed on a respective end of a substantially cylindrical member 315A, 315B, 315C.

In this embodiment, the potato tuber 320 can be moved through the cutting apparatus 320, which will cut the potato tuber into cylindrical rings 332 having different diameters and an inner core 331. The cylindrical rings 332 are temporarily contained in the substantially cylindrical members 315B, 315C, and the inner core 331 is temporarily contained in the substantially cylindrical member 315A.

According to the invention, it is preferable to separate the cylindrical rings 332 from the inner core 331. The cylindrical rings 332 can be ejected from the cutting apparatus 300 and collected for further processing. The core 331 can be is separately ejected from cutting apparatus 300 and transported for further processing or disposal. The collected cylindrical rings 332 are then sliced at various points along the length of the outer cylindrical rings 332 in a direction substantially perpendicular to the cutting direction of the cutting apparatus 300, as shown in FIG. 12C. Thus, a plurality of sliced rings are formed from the slicing of the cylindrical rings 332. The processes for ejecting all of the cylindrical rings 330 and slicing the outer cylindrical rings 332 can be any process known to those of skill in the art.

### EXAMPLES

### Quality Differences for French Fries from Outer Versus Inner Potato Strips

Peeled tubers of the variety Russet Burbank were cut into strips with a width and depth of 0.7 cm and an average length of 8 cm. The four innermost strips of each tuber were used as “inner” strips, whereas the four-to-eight strips closest to the periphery represented the “outer” strips. The groups of strips were weighed, freeze-dried, and weighed again to determine their moisture content by dividing the weight before freeze-drying by the weight after freeze-drying and multiplying this ratio by 100%. Inner strips were found to contain 81.91±1.73% but this percentage was only 77.30±2.49% for outer strips.

To determine the effect of the compositional differences of tubers on French fry quality, the two groups of strips were blanched, dried, and fried according to standard procedures that had been established using mixed potato strips from the entire peeled tuber. Basically, potato strips were cut from peeled tubers of the variety Russet Burbank with a grid of knife blades. Potato rings were obtained by first cutting peeled tubers into discs with a slicer set at 7-mm and then cutting the discs with a custom-made double cylindrical knife, whereby the diameters of the inner and outer blade were 30 mm and 44 mm, respectively. Standard procedures for French fry production consisted of a blanching step (9-min at 74° C.), followed by a dip in 0.5% disodium acid pyrophosphate (SAPP) and 0.3 dextrose (45-s at 77° C.), drying (6-min at 77° C.), par-frying (45-s at 191° C.), freezing (overnight at −80° C.), and finish-frying (3-min and 10-s at 168° C.).

Processed potatoes were sampled three minutes after finish-frying. They were rated by a panel of eight trained members for color, crispness, mealiness, and flavor on an arbitrary scale from 1 to 9, whereby ratings below 7.5 were considered as “not enough”, and ratings above 7.5 as “too much” of the trait. Variation in color and texture were assessed by using a scale from 5 (fully uniform) to 9 (highly-variable).

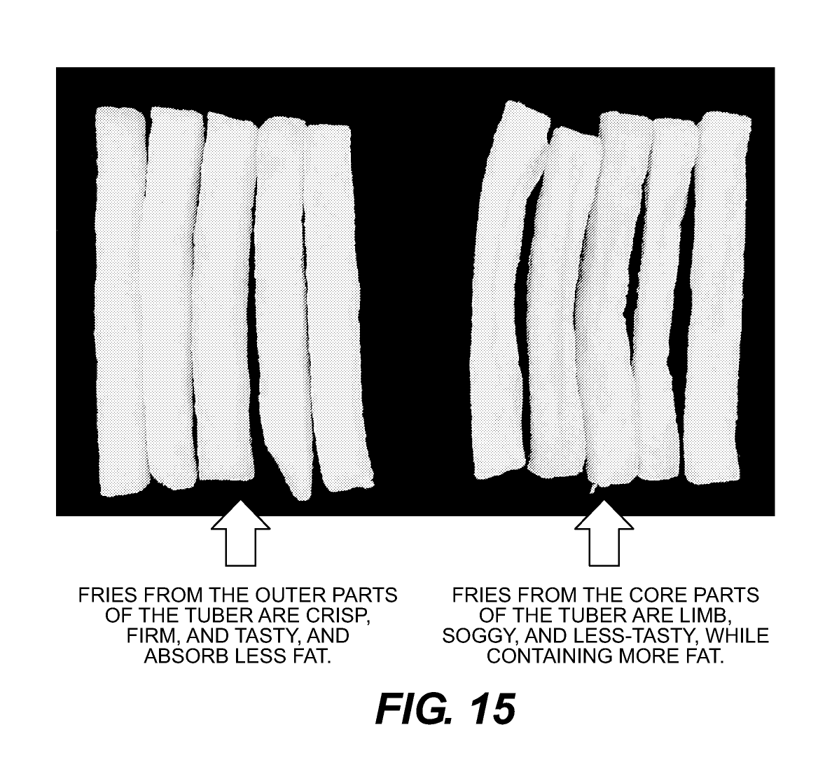

The sensory panel found that French fries from outer strips displayed excellent characteristics; they had a consistently good first bite feel (crispness), a good mouth feel of the internal flesh (texture), while also displaying a desirable color and flavor (Table 1 and FIG. 15). In contrast, fries from the inner strips were too light, limp, and tasteless, and appeared undercooked. Conventionally-produced French fries from the entire peeled tuber were intermediary in terms of crispness and flavor, and also displayed a greater variation in color and texture (Table 1 and FIG. 15). A more precise comparison between the quality potential of the various potato tissues was made by removing the apical and basal ends of tubers prior to processing. Removal of the tuber-end tissues produced strips with an exact length of 7 cm. Inner strips had an even higher moisture content than those from whole tubers. As expected, the resulting short fries from the inner tuber parts exhibited inferior sensory characteristics, especially for flavor (Table 1). Collectively, these results demonstrate that the quality of French fries is compromised when strips from the inner parts of potato tubers were processed using standard methods.

To optimize processing parameters for segregated inner strips, the time of drying and frying times were extended by 1-min steps. Sensory evaluations of the resulting fries demonstrated that a 2-min extension of drying time, together with a 2-min increase in the time of frying, enhanced the color and crispness of inner fries to levels that were typical of outer fries prepared according to standard protocols (Table 2). When applied to outer strips, the modified process produced dark and overcooked fries that were unacceptable for commercial application (data not shown). The French fries that had been prepared using standard parameters were analyzed for their water and oil content. FIG. 3 shows that the moisture content of inner fries was 50.83±0.53% whereas outer fries contained 44.53±1.07% moisture. Thus, potato strips lost about 31% of their water during drying and frying. Part of this lost water was replaced by oil. The outer fries absorbed less oil (9.8%) than the inner fries (12.5%) (FIG. 4). Inner fries contained even more oil when they were processed for a longer time to enhance their sensory characteristics (12.8%).

The two groups of fries were also analyzed for levels of the Maillard product acrylamide. Biochemical studies on inner and outer potato strips did not indicate any differences in the potential to form this neurotoxin because they contained similar amounts of the acrylamide precursors glucose, fructose, and asparagine (FIGS. 5A and B). However, an analysis of French fries that had been prepared using standard parameters demonstrated that inner fries contained 759 parts per billion (ppb) acrylamide, which was slightly higher than the amount of acrylamide produced in outer fries (721 ppb) (FIG. 5C). This finding was unexpected because the high moisture content of inner fries delays the cooking process, which is known to also impair acrylamide formation. The difference in acrylamide formation was much more pronounced when frying procedures were adjusted to produce inner fries with the same color and crispness as outer fries. In this case, inner fries accumulated 1172 ppb acrylamide, which is 63% higher than what accumulated in similarly colored and crisp outer fries (FIG. 5C).

Another difference in quality between outer and inner fries relates to antioxidants.

Biochemical analyses showed that strips for outer fries contained more vitamin C than inner strips (0.054±0.003 versus 0.050±0.003 mg/g FW) (FIG. 5D). They also accumulated higher levels of the polyphenolic antioxidant chlorogenic acid (0.026±0.005 versus 0.020±0.003 mg/g FW) (FIG. 5C). Thus, it can be concluded that outer fries are not only more appealing but also healthier than inner fries because they contain less oil and acrylamide and more antioxidants.

### Example 2

### The Quality of Ring Fries is Superior to that of Conventional French Fries

The amount of oil absorption and acrylamide formation is not just based on whether potato strips are derived from inner or outer tissues but also on the surface-to-volume ratio (SVR) of strips. SVRs were calculated by using software programs that are freely accessible at, for instance, http://www.livephysics.com/tools/math/area-and-volume-calculator.html.

Strips with a greater SVR ratio were expected to absorb more oil than strips with the same volume but a lower SVR. Thus, new methods for the production of healthier French fries were considered that would not only use the outer parts of potato tubers but also reduce the SVR by altering the shape of strips. Tuber rings are an example, where the tuber is first cut into 0.7 cm discs and then the inner core and the outer skin are removed with a double cylindrical knife (FIG. 6A). The rings have, like linear strips, a width and depth of 0.7 cm. However, the surface of a ring with a volume of 4.9 cm³ is 22.5 cm2 (SVR=4.60), which is only 77.7% of the surface of a typical 0.7×0.7 cm linear strip with a volume of 4.9 cm³ (29.0 cm2) and SVR of 5.9. The inner diameter of these rings was 30 mm.

Unexpectedly, it was found that the moisture content of rings was even lower than that of outer strips (FIG. 6C). This finding indicates that rings better capture the high dry matter parts of potato. The oil content of the ring fries processed according to the standard method described above was compared with the two groups of conventionally prepared linear fries.

Oil content was determined by homogenizing 1 g of finish-fried potato (total weight) was homogenized with 2 ml of dichloromethane using a bullet blender (2×9-min). Filtered extract was dried over anhydrous sodium sulfate. The oil percentage was calculated by multiplying the ratio dried extract/total weight by 100.

As expected, the high solids content and low SVR of ring fries correlated with a greatly reduced absorption of oil compared to conventional fries (FIG. 6D). The difference in oil absorption was greatest when ring fries were compared with fries from the inner tuber parts. A further benefit of the low SVR is that it limits the amount of salt per gram of fries. The difference was very similar to the calculated 22.3% difference in SVRs (FIG. 6E). This effect was accomplished without lowering the salty perception of fries as determined by a sensory evaluation (FIG. 6F). The sensory analysis also found that ring fries were more uniform in terms of color and texture than mixed fries, and they were crisper, mealier, and more flavorful.

The low SVR of ring fries would be expected to lower the accumulation of acrylamide because this compound is mainly formed at the surface. In addition, the raw material used to produce ring fries contained 18.4% less asparagine than the strips from inner potato tissues (FIG. 7A), which should also limit the formation of acrylamide.

Asparagine and other amino acids were extracted by homogenizing 250 mg ground freeze dried potato strips or rings with 5 μmoles sarcosine as an internal standard in 3.0 mL of a 0.03 M Triethylamine HCl buffer, adding (a) 150 μl potassium hexacyanoferrate trihydrate, (b) 150 p. 1 zinc sulfate, and (c) 250 μl 0.1 N NaOH with 3.0 mL 0.03 M TEA buffer, whereby the mixture was vortexed after each addition. The extract was centrifuged for 15 min at 4° C., 40000 rpm, and supernatant was transferred to a new tube. The pellet was re-suspended in 5 mL nanopure water and centrifuged. Supernatant was pooled with the first tube and adjusted final volume to 12.5 mL with water. The extracted free amino acids were derivatized using EZ:faast method according to the users' manual from Phenomenex. Derivatized samples were analyzed by liquid chromatography-mass spectrometry (LC-MS) using an Agilent 1200 series HPLC system coupled with a 6300 series ion trap. Bruker's quant analysis software was used for quantification. For HPLC, the column used was EZ:faast AAA-MS column 250×3.0 mm, and the mobile phase was 10 mM ammonium formate in water and 10 mM ammonium formate in methanol using a gradient. MS was run in positive mode with ESI and auto MSn.

Sugars were extracted by shaking about 150 mg freeze dried strips or rings in 1 mL of 60% ethanol at 80° C. for one hour. The supernatant was transferred to a fresh tube and the pellet was re-extracted with 1 mL ethanol by incubating it for 30 min at 80° C. Supernatant was then evaporated in a speedvac until the remaining volume was about 60-70 μl. A known amount of Ribose was added as internal standard. Sugar analyses were performed on an Agilent's HPLC system 1200 series which consists of auto sampler, Zorbax carbohydrate column (4.6×150 mm), a solvent system of acetonitrile-water (75:25), a flow rate of 1 mL/min, and a refractive index detector. Sugars were quantified by Agilent's software ChemStation using external calibration.

The analysis of glucose and fructose levels found no differences between inner or outer strips versus rings (FIG. 7B and data not shown). It was found that ring fries accumulated only 385.1±13.3 ppb acrylamide (FIG. 7C). This level is 27.4% lower than that for outer fries (530.7±11.4 ppb). Again, inner fries that had been processed to resemble outer fries in color and crispness were shown to contain the highest level of acrylamide (FIG. 7C).

A comparison between the ring strips and linear strips from the inner core also found an even greater difference in antioxidant levels as measured previously for outer versus inner strips. The ring strips contained 21.1±2.6% more vitamin C, and 52.9±14.3% more chlorogenic acid, as inner cores (FIG. 7D).

### Example 3

### Product Recovery

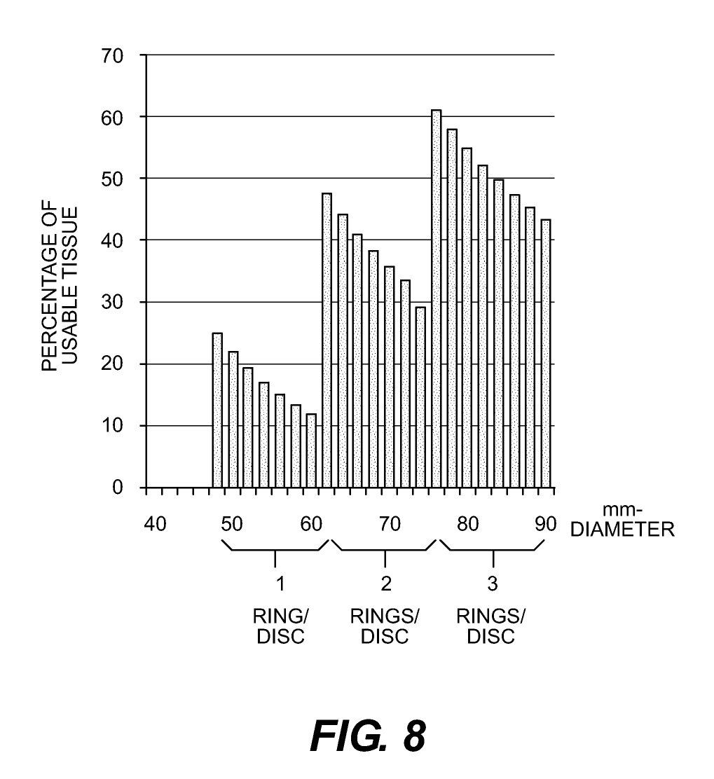

The cost of ring fry production is based, in part, on the recovery rate for ring strips. This recovery rate depends on the shape, especially the diameter, of tubers (FIG. 8). Tubers with a diameter below about 48 mm are generally not considered for conventional French fries and would also be too narrow for the production of ring fries. Such tubers can better be used for, for instance, hash browns or dehydrated potato flakes. A minimum diameter of about 48 mm makes it possible to produce 8-12 discs/tuber whereby each disc yields a single ring. The resulting rings represent about 25% of the total tuber material, which means that the remaining 75% of the tuber (basal and apical caps, the skin with cortex, and the inner core) would have to be designated for alternative applications. It is theoretically possible to produce discs with a diameter of at least about 62 mm that can be used to obtain two concentric rings with inner diameters or 30 mm and 44 mm, respectively. The recovery rate for ring fries from such medium-sized tubers is, in fact, relatively high at almost 50%. The most efficient tubers have a diameter of about 76 mm; discs of such tubers yield three concentric rings, and support recovery rates of more than 60%.

The recovery rate for rings with an inner diameter of 29 and 43 mm, respectively, is shown in Table 3. It indicates that the recovery rate for tubers with a diameter of 55 mm is 65%.

There is an economic incentive to limit the amount of by-product that is generated during the production of ring fries. It may, therefore, be most effective to produce ring fries in a processing plant designed to also make French fries. A conventional sorting system can be used to segregate, for instance, the 20% of tubers with an optimal diameter of 76 mm for ring fry production in an independent product line. Process efficiency can be further enhanced by employing varieties that have unusually narrow pith regions. One such a variety is Innovator, which has an inner core with a diameter of only 13-18 mm (Heap, unpublished results). Tubers of this variety could be used to make an additional ring per disc.

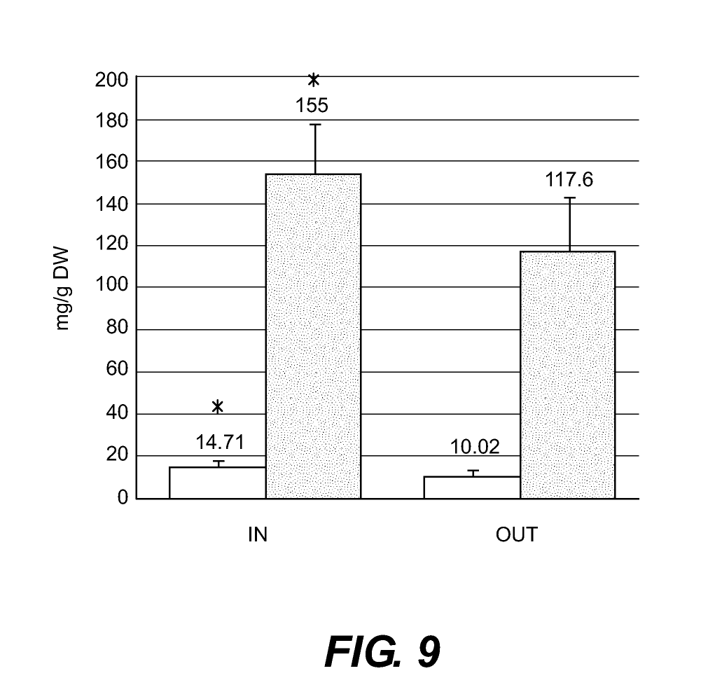

The inner part of the potato tuber, the watery core, was shown to contain the same amount of amino acids as the outer tissues on a fresh-weight basis. Thus, these tissues contain much more amino acids per gram dry weight (DW) (FIG. 9). There is an even greater differential between inner and outer tissues for protein levels (FIG. 9). It was, therefore, proposed to use the inner parts of tubers for the production of amino acid and protein-rich dehydrated mashed potato flakes.

It has been shown herein that inconsistencies in the color, texture, and taste of French fries are due, in part, to structural differences within the tuber. The extensive water content of potato strips from the inner tissues delay the cooking process of these strips. Thus, the application of a standard frying process for strips from both the inner and outer parts of potato produced not only golden-colored and tasty but also undercooked fries. The longer drying and frying times that were needed to enhance the sensory characteristics of inner fries resulted in overcooked outer fries that were dry and brown. Apart from differences in sensory characteristics, fries from outer tissues absorbed less vegetable oil, accumulated less acrylamide, and contained more antioxidants than those from the inner parts. Thus, the exclusive use of potato strips from the outer parts of potato produces tastier and healthier French fries.

A further improvement was achieved by not only excluding the inner core of potato but by also lowering the surface-to-volume ratio (SVR) of the material that is used to produce fries. In the example described here, tubers are sliced into 7 mm discs, and the discs are then cut with a double cylindrical knife to produce potato rings (commercial applications may be different). The SVR of potato rings is only 77.7% that of potato strips. The resulting ring fries contain even less oil and acrylamide than fries from the outer tuber parts, and they also contain less salt. Given their sensory and health benefits, ring fries may be perceived as a welcome alternative to linear fries that became popular in the 1960s.

The estimated recovery rate for ring fries varies between 25-60%, which is lower than that currently achieved for French fries (above 60%). During this early phase of the development process, it may be most cost effective to only select tubers with an optimal diameter for ring fry production. Such a sorting can best be carried out in a plant where most of the tubers are still destined for French fry production. New efforts to breed for more uniform potato varieties and to improve upon ring processing may result in a gradual increase in ring fry production.

The tuber parts peripheral to rings amount to 20-30% of the raw material, and consist mainly of cortex, periderm, and skin. These parts are particularly rich in dietary fibers and antioxidants, but may also contain small amounts of glycoalkaloids, pesticide residues, and remnants of the sprout inhibitor chloropropham. Possible applications of these by-products include animal feed and fermentation for the production of bioethanol. The inner tissues of potato tubers are most suitable for dehydration. Their relatively high protein and amino acid on a dry-weight basis would increase the nutritional value of the product. Some of the potato by-product material may also be used for new applications. For instance, potatoes can be fermented to produce xanthan gum, a stabilizer and thickener used in the paint and chemical industry, or the polylactic acid that is used for non-petroleum based plastics.

The studies presented in this paper provide justification for a partial replacement of French fries by ring fries. Such ring fries are not only healthier and tastier than conventional French fries, they also have a new and unexpected shape that is perceived as desirable. By carefully sorting and processing optimally-sized tubers, the production cost for ring fries may approach those for French fries.

### Example 4

### Hexagon Fries

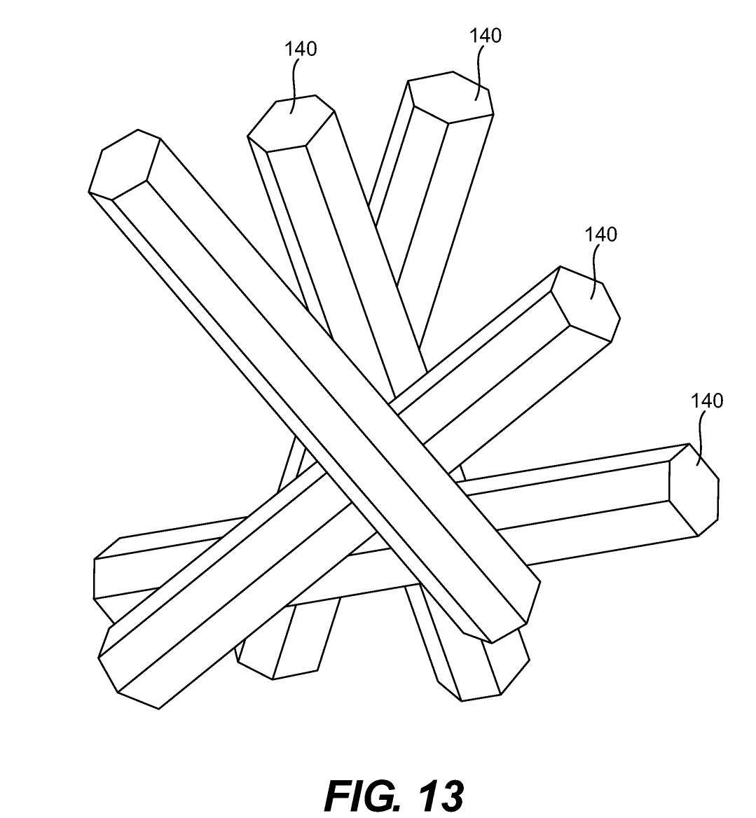

French fries are always made in block shapes whereby the width is equal to the depth. This shape represents a very high surface to volume ratio. A reduction of this ratio will result in a reduction in the amount of fat absorption and acrylamide formation. Unique honeycomb-shaped knives will be used to cut potatoes efficiently to produce hexagon strips (FIG. 13). These strips can be used to produce new fun foods that contain a 18.5% lower surface-to-volume ratio than conventional strips. Consequently, the resulting hexagon fries absorb about 18.5% less oil, and contain about 18.5% less salt, and less acrylamide per gram than conventional fries. Further quality improvements can be obtained by only using the outer parts of potatoes, whereas the appeal can be enhanced by using one or several differently colored flesh varieties. Thus, it is possible to produce healthy and appealing yellow, red, purple, or golden-colored hexagon fries or a mix thereof.

Instead of hexagon cutters (FIG. 14), it is also possible to use cutters consisting of multiple cylindrical knives to produce round strips. Such strips have the lowest possible surface-to-volume ratio, which is about 30% lower than block fries, and can be used to produce fries with a much lower content of oil, salt, and acrylamide than conventional French fries. Further quality improvements can be obtained by only using the outer parts of potatoes, whereas the appeal can be enhanced by using colored flesh varieties.

### Example 5

### Idaho Sushi

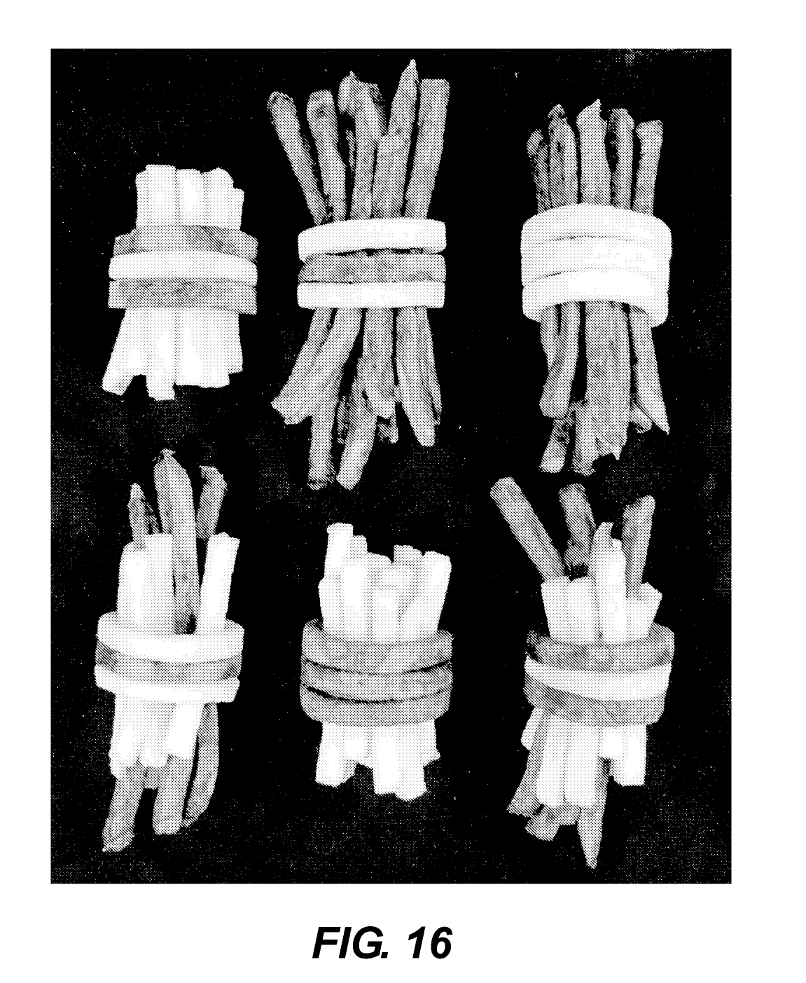

The Idaho Sushi is a processed potato product comprising several linear fries, either conventional French fries or, for instance, cylindrical or hexagonal fries, kept together by several omega fries. The Idaho sushi is produced by cutting, blanching, and par-frying the various components separately. After these preliminary steps, the components are put together and frozen and shipped to restaurants or retailers. The single final step consists of finish frying the assembled fries (see, for example, FIG. 16).

TABLE 1
Sensory evaluation of French fries from outer, inner, or mixed potato strips¹.

| | | Sensory Rating | | | | | |
|---|---|---|---|---|---|---|---|
| | | | Color | | | Texture | |
| Sample | Process | Color² | Variation | Crispness | Mealiness² | Variation³ | Flavor² |
| Out | Standard | 7.6 ± 0.52 | 6.1 ± 0.35 | 6.5 ± 0.53 | 6.3 ± 0.46 | 5.3 ± 0.35 | 7.1 ± 0.64 |
| In | Standard | 6.1 ± 0.35 | 6.4 ± 0.52 | 4.4 ± 0.52 | 5.3 ± 0.46 | 5.7 ± 0.35 | 5.5 ± 0.52 |
| Mix | Standard | 7.2 ± 0.46 | 7.4 ± 0.46 | 5.8 ± 0.46 | 5.3 ± 0.46 | 6.6 ± 0.46 | 6.0 ± 0.52 |
| Out- | Standard | 7.1 ± 0.35 | 5.5 ± 0.35 | 6.8 ± 0.52 | 6.1 ± 0.52 | 5.2 ± 0.46 | 7.2 ± 0.46 |
| Middle | | | | | | | |
| In- | Standard | 5.4 ± 0.46 | 5.0 ± 0.35 | 4.1 ± 0.52 | 5.1 ± 0.52 | 5.7 ± 0.46 | 5.0 ± 0.46 |
| Middle | | | | | | | |

¹superior ratings (P < 0.05) are shown in bold;
²sensory characteristics were rated on an arbitrary scale from 1-9, whereby 7.5 was considered optimal and lower or higher values indicating “not enough” and “too much”, respectively;
³the variation within a sample was rated on an arbitrary scale between 5 (fully-uniform) and 9 (highly-variable).

TABLE 2
Optimization of French fry processing using inner potato strips¹.

| | | Sensory Rating | | | | | |
|---|---|---|---|---|---|---|---|
| | | | Color | | | Texture | |
| Sample | Process² | Color | Variation | Crispness | Mealiness | Variation | Flavor |
| Out | Standard | 7.0 ± 0.38 | 5.7 ± 0.49 | 5.7 ± 0.49 | 6.0 ± 0.00 | 5.4 ± 0.53 | 6.8 ± 0.81 |
| (control) | | | | | | | |
| In | 8:00/4:10 | 6.9 ± 0.38 | 6.7 ± 0.49 | 4.7 ± 0.49 | 4.9 ± 0.38 | 6.1 ± 0.38 | 5.5 ± 0.50 |
| In | 8:00/5:10 | 7.1 ± 0.38 | 6.9 ± 0.38 | 6.4 ± 0.53 | 5.6 ± 0.53 | 5.7 ± 0.49 | 6.6 ± 0.63 |
| In | 10:00/4:10 | 7.7 ± 0.49 | 6.6 ± 0.53 | 5.9 ± 0.38 | 5.0 ± 0.0 | 6.4 ± 0.53 | 6.0 ± 0.0 |
| In | 10:00/5:10 | 7.9 ± 0.38 | 7.1 ± 0.38 | 6.7 ± 0.49 | 5.6 ± 0.53 | 6.4 ± 0.53 | 6.4 ± 0.85 |

¹Superior ratings (P < 0.05) are shown in bold.;
²times indicated are for drying/frying.

TABLE 3
Recovery percentage

| | | Core vol | | | |
|---|---|---|---|---|---|
| Diameter | Core cut | (mm³) | ring 1^{a} | ring 2^{b} | % recov |
| 50 mm | 15 mm | 1236 | 3385 | 5539 | 65% |
| 55 mm | 15 mm | 1236 | 3385 | 5539 | 54% |
| 60 mm | 15 mm | 1236 | 3385 | 5539 | 45% |

^{a}inner diameter = 29 mm,
^{b}inner diameter = 43 mm

What is claimed is:

1. An uncooked potato product that is either (1) a potato strip comprising at least six sides and which has a surface area-to-volume ratio lower than the surface area-to-volume ratio of a conventional potato product that has a rectangular cross-sectional shape of the same volume and height, or (2) a potato ring, wherein the potato product has at least one enhanced sensory characteristic compared to a conventional potato product when it is heat-processed.

2. The uncooked potato product of claim 1, wherein the potato product is cut from the outer region of the potato.

3. The uncooked potato product of claim 1, wherein the sensory characteristic is selected from the group consisting of texture, taste, color, and uniformity.

4. The uncooked potato product of claim 1, wherein the potato product, when it is heat-processed, has low levels of at least one of acrylamide, salt, and oil content.

5. The uncooked potato product of claim 2, wherein the potato product accumulates approximately 1-20 parts per billion (ppb), 20-40 ppb, 40-60 ppb, 60-80 ppb, 80-100 ppb, 100-120 ppb, 120-140 ppb, 140-160 ppb, 160-180 ppb, 180-200 ppb or 200-220 ppb less acrylamide when it is heat-processed than a potato product of the same dimensions that is cut from the inner region of the potato.

6. The uncooked potato product of claim 2, wherein the potato product has about 10% less oil content (% by weight), about 11% less oil content (% by weight), about 12% less oil content (% by weight), about 13% less oil content (% by weight), about 14% less oil content (% by weight), about 15% less oil content (% by weight), about 16% less oil content (% by weight), about 17% less oil content (% by weight), about 18% less oil content (% by weight), about 19% less oil content (% by weight), or about 20% less oil content (% by weight) than a potato product of the same dimensions that is cut from the inner region of the potato.

7. The uncooked potato product of claim 2, wherein the potato product comprises high levels of any least one of chlorogenic acid and vitamin C than a potato product of the same dimensions that is cut from the inner region of the potato.

8. A collection of the potato products, wherein substantially all of the potato products in the collection are cut from the outer region of a potato.

9. The collection of claim 8, wherein substantially all of the potato products are either (1) strips comprising at least six sides and each of which has a surface area-to-volume ratio lower than the surface area-to-volume ratio of a conventional potato product that has a rectangular cross-sectional shape of the same volume and height, or (2) potato rings.

10. The collection of claim 8, comprising a mixture of (1) potato strips that have at least six sides, and (2) potato rings.

11. A method of producing a potato product, comprising (1) cutting a strip from a potato tuber, wherein the strip has a surface area-to-volume ratio that is lower than the surface area-to-volume ratio of a strip of rectangular cross-sectional shape having the same volume and height, or (2) cutting a ring from a potato tuber, wherein the strip or ring is either (i) cut from the outer region of the potato, or (ii) cut from a potato tuber that is obtained from a recombinant potato plant that comprises a downregulated expression of at least one of an R1 gene, phosphorylase-L gene, and an asparagine synthetase compared to the expression of that gene in a non-recombinant potato plant.

12. The method of claim 11, wherein the potato tuber comprises low levels of at least one of a reducing sugar and asparagine.

13. The method of claim 12, further comprising heat-processing the potato product by frying, deep-frying, par-frying, baking, boiling, searing, roasting, or blanching.

14. The method of claim 10, wherein the heat-processed potato product has low levels of at least one of acrylamide, oil content, and salt after it is heat-processed.
